(19) United States
(12) Patent Application Publication
(10) Pub. No.: US 2024/0117184 A1
(43) Pub. Date: Apr. 11, 2024

(54) POLYCARBONATE RESIN COMPOSITION AND MOLDED ARTICLE

(71) Applicant: TEIJIN LIMITED, Osaka-shi, Osaka (JP)

(72) Inventor: Kouji ODA, Osaka (JP)

(73) Assignee: TEIJIN LIMITED, Osaka-shi, Osaka (JP)

(21) Appl. No.: 18/275,109

(22) PCT Filed: Dec. 14, 2021
(86) PCT No.: PCT/JP2021/046005

§ 371 Date: Jul. 31, 2023

(30) Foreign Application Priority Data
Feb. 2, 2021 (JP) 2021-014983

(51) Int. Cl. C08L 83/10; C08L 69/00

(52) U.S. Cl. CPC C08L 83/10; C08L 69/00; C08L 2201/02; C08L 2205/025

(57) ABSTRACT

The present invention provides a polycarbonate resin composition having excellent low-temperature impact resistance, durability, and flame retardancy. The present invention is directed to a polycarbonate resin composition comprising, relative to 100 parts by weight of a resin component containing 10 to 90 parts by weight of (A) a polycarbonate-polydiorganosiloxane copolymer (component A) and 90 to 10 parts by weight of (B) a polycarbonate resin (component B), 0.5 to 7 parts by weight of (C) a phosphazene compound (component C) and 0.1 to 0.5 parts by weight of (D) a fluorine-containing anti-dripping agent (component D), wherein the ratio of the viscosity average molecular weight of the component A to that of the component B (Mv (component A)/Mv (component B)) is 1 to 1.5, and the component A satisfies the following (i) and (ii): (i) the component A is a polycarbonate-polydiorganosiloxane copolymer comprising a polycarbonate block represented by the following general formula [1] and a polydiorganosiloxane block represented by the following general formula [3]; and (ii) the component A has a viscosity average molecular weight of 23,000 to 30,000.

### TECHNICAL FIELD

The present invention relates to a polycarbonate resin composition and a molded article. More particularly, the present invention is concerned with a polycarbonate resin composition which has a phosphazene compound and a fluorine-containing anti-dripping agent incorporated into a resin component containing a polycarbonate-polydiorganosiloxane copolymer and a polycarbonate resin wherein the polycarbonate-polydiorganosiloxane copolymer and the polycarbonate resin have a specific ratio of the viscosity average molecular weight, and which thus has improved low-temperature impact resistance, durability, and flame retardancy, and a molded article.

### BACKGROUND ART

Polycarbonate resins have excellent properties including mechanical strength, dimensional stability, and flame retardancy, and therefore have been used in various applications, such as mechanical parts, automobile parts, electric or electronic parts, and office appliance parts. Enclosures for outdoor use, for example, an outdoor electric or electronic container box, such as an information communication box, and a junction box for solar power generation, are required to have thin-wall flame retardancy, high impact resistance in a low-temperature environment for use in winter, and further such durability that the resin is, for example, rated UL 746C f1, or unlikely to deteriorate even when exposed to an ultraviolet light or weather, and the conventional polycarbonate resin cannot achieve satisfactory performance.

As a method for improving the low-temperature impact resistance properties and durability, there has been proposed a method using a polycarbonate-polydiorganosiloxane copolymer, in which polytetrafluoroethylene particles or an organometal salt flame retardant is incorporated into the polycarbonate-polydiorganosiloxane copolymer (PTLs 1 and 2). However, the composition obtained by the above method cannot achieve satisfactory thin-wall flame retardancy, and has unsatisfactory flame retardancy after the water exposure test for the UL 746C f1 rating. Further, the polycarbonate-polydiorganosiloxane copolymer obtained by a general polymerization method is cloudy and opaque, and a resin composition using such a copolymer has problems about coloring properties (PTLs 3 and 4). Meanwhile, as a method for imparting more excellent flame retardancy, the use of a phosphazene compound which is a phosphorus flame retardant has been proposed (PTLs 5 and 6). However, there is a disadvantage in that the addition of a phosphazene compound reduces the impact resistance. Further, these documents do not have a description about a polycarbonate resin, showing that, by selecting a polycarbonate-polydiorganosiloxane copolymer and a polycarbonate resin with a specific ratio of the viscosity average molecular weight, high durability and low-temperature impact resistance can be obtained even when adding a phosphazene compound.

### CITATION LIST

### Patent Literature

PTL 1: JPH08−81620A
PTL 2: WO2011/1551490
PTL 3: JP2662310B
PTL 4: JPH03−79626A
PTL 5: JP2013−1801A
PTL 6: JP2012−1580A

### SUMMARY OF INVENTION

### Technical Problem

An object of the present invention is to provide a polycarbonate resin composition having excellent low-temperature impact resistance, durability, and flame retardancy, and a molded article.

### Solution to Problem

The present inventor has conducted extensive and intensive studies with a view toward solving the above-mentioned problems. As a result, it has been found that, by incorporating a phosphazene compound and a fluorine-containing anti-dripping agent into a resin component containing a polycarbonate-polydiorganosiloxane copolymer and a polycarbonate resin wherein the polycarbonate-polydiorganosiloxane copolymer and the polycarbonate resin have a specific ratio of the viscosity average molecular weight, a polycarbonate resin composition having excellent low-temperature impact resistance, durability, and flame retardancy can be obtained. According to the present invention, the problems can be solved by a polycarbonate resin composition which comprises, relative to 100 parts by weight of a resin component containing 10 to 90 parts by weight of (A) a polycarbonate-polydiorganosiloxane copolymer (component A) and 90 to 10 parts by weight of (B) a polycarbonate resin (component B), 0.5 to 7 parts by weight of (C) a phosphazene compound (component C) and 0.1 to 0.5 parts by weight of (D) a fluorine-containing anti-dripping agent (component D), wherein the ratio of the viscosity average molecular weight of the component A to that of the component B (Mv (component A)/Mv (component B)) is 1 to 1.5, and the component A satisfies the following (i) and (ii):

(i) the component A is a polycarbonate-polydiorganosiloxane copolymer comprising a polycarbonate block represented by the following general formula [1] and a polydiorganosiloxane block represented by the following general formula [3]; and

(ii) the component A has a viscosity average molecular weight of 23,000 to 30,000,

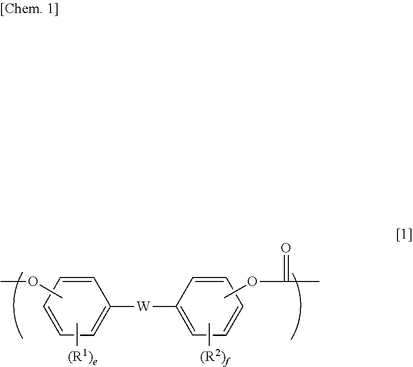

wherein, in the general formula [1], each of R¹ and R² independently represents a group selected from the group consisting of a hydrogen atom, a halogen atom, an alkyl group having 1 to 18 carbon atoms, an alkoxy group having 1 to 18 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 14 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, each of e and f is an integer of 1 to 4, and W is a single bond or at least one group selected from the group consisting of groups represented by the following general formula [2]:

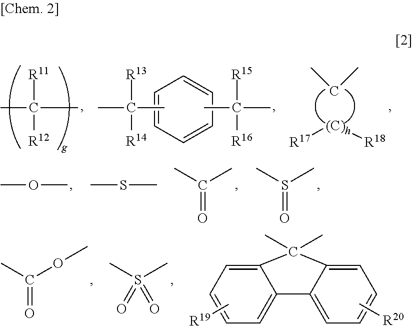

wherein, in the general formula [2], each of R¹¹, R¹², R¹³, R¹⁴, R¹⁵, R¹⁶, R¹⁷, and R¹⁸ independently represents a group selected from the group consisting of a hydrogen atom, an alkyl group having 1 to 18 carbon atoms, an aryl group having 6 to 14 carbon atoms, and an aralkyl group having 7 to 20 carbon atoms, each of R¹⁹ and R²⁰ independently represents a group selected from the group consisting of a hydrogen atom, a halogen atom, an alkyl group having 1 to 18 carbon atoms, an alkoxy group having 1 to 10 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 10 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, g is an integer of 1 to 10, and h is an integer of 4 to 7,

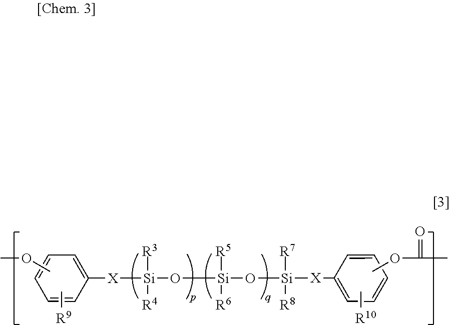

wherein, in the general formula [3], each of R³, R⁴, R⁵, R⁶, R⁷, and R⁸ is independently a hydrogen atom, an alkyl group having 1 to 12 carbon atoms, or a substituted or unsubstituted aryl group having 6 to 12 carbon atoms, each of R⁹ and R¹⁸ is independently a hydrogen atom, a halogen atom, an alkyl group having 1 to 10 carbon atoms, or an alkoxy group having 1 to 10 carbon atoms, p is a natural number, q is 0 or a natural number, wherein the average chain length p+q is a natural number of 30 to 60, and X is a divalent aliphatic group having 2 to 8 carbon atoms.

### Advantageous Effects of Invention

The resin composition of the present invention achieves very excellent low-temperature impact resistance, durability, and flame retardancy, and thus is advantageously used in a wide variety of fields, such as a housing facilities application, a building material application, a life material application, an infrastructure facilities application, an automotive application, and an OA and EE application, and particularly advantageously used in an outdoor application that requires durability. Therefore, the present invention is of extremely great industrial significance.

### DESCRIPTION OF EMBODIMENTS

Hereinbelow, the present invention will be described in detail.

### (Component A: Polycarbonate-Polydiorganosiloxane Copolymer)

The polycarbonate-polydiorganosiloxane copolymer used as the component A is a polycarbonate-polydiorganosiloxane copolymer comprising a polycarbonate block represented by the following general formula [1] and a polydiorganosiloxane block represented by the following general formula [3]:

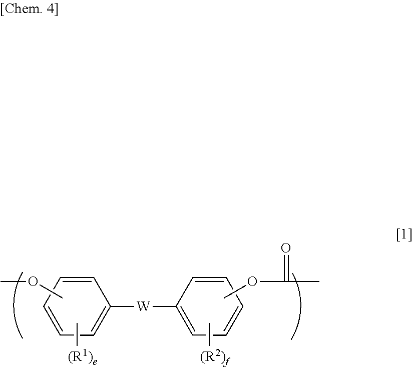

wherein, in the general formula [1], each of R¹ and R² independently represents a group selected from the group consisting of a hydrogen atom, a halogen atom, an alkyl group having 1 to 18 carbon atoms, an alkoxy group having 1 to 18 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 14 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, each of e and f is an integer of 1 to 4, and W is a single bond or at least one group selected from the group consisting of groups represented by the following general formula [2]:

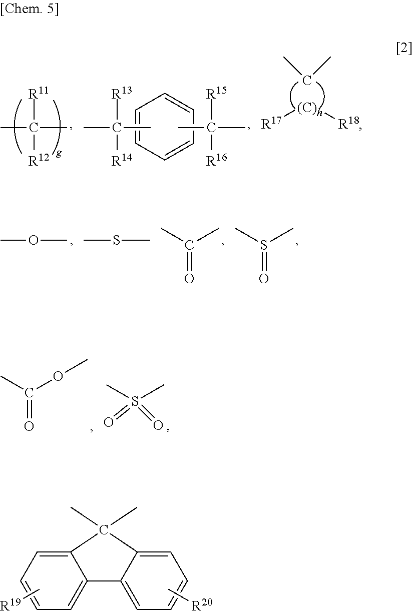

wherein, in the general formula [2], each of R¹¹, R¹², R¹³, R¹⁴, R¹⁵, R¹⁶, R¹⁷, and R¹⁸ independently represents a group selected from the group consisting of a hydrogen atom, an alkyl group having 1 to 18 carbon atoms, an aryl group having 6 to 14 carbon atoms, and an aralkyl group having 7 to 20 carbon atoms, each of R¹⁹ and R²⁰ independently represents a group selected from the group consisting of a hydrogen atom, a halogen atom, an alkyl group having 1 to 18 carbon atoms, an alkoxy group having 1 to 10 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 10 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, g is an integer of 1 to 10, and h is an integer of 4 to 7,

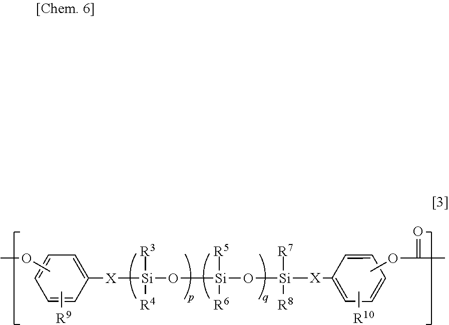

wherein, in the general formula [3], each of R³, R⁴, R⁵, R⁶, R⁷, and R⁸ is independently a hydrogen atom, an alkyl group having 1 to 12 carbon atoms, or a substituted or unsubstituted aryl group having 6 to 12 carbon atoms, each of R⁹ and R¹⁸ is independently a hydrogen atom, a halogen atom, an alkyl group having 1 to 10 carbon atoms, or an alkoxy group having 1 to 10 carbon atoms, p is a natural number, q is 0 or a natural number, wherein the average chain length p+q is a natural number of 30 to 60, and X is a divalent aliphatic group having 2 to 8 carbon atoms.

With respect to the dihydric phenol (I) that derives the carbonate constitutional unit represented by the general formula [1] above, examples of the dihydric phenols include 4,4′-dihydroxybiphenyl, bis(4-hydroxyphenyl)methane, 1,1-bis(4-hydroxyphenyl)ethane, 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)-3,3,5-trimethylcyclohexane, 2,2-bis(4-hydroxy-3,3′-biphenyl)propane, 2,2-bis(4-hydroxy-3-isopropylphenyl) propane, 2,2-bis(3-t-butyl-4-hydroxyphenyl)propane, 2,2-bis(4-hydroxyphenyl)butane, 2,2-bis(4-hydroxyphenyl)octane, 2,2-bis(3-bromo-4-hydroxyphenyl)propane, 2,2-bis(3,5-dimethyl-4-hydroxyphenyl)propane, 2,2-bis(3-cyclohexyl-4-hydroxyphenyl)propane, 1,1-bis(3-cyclohexyl-4-hydroxyphenyl)cyclohexane, bis(4-hydroxyphenyl)diphenylmethane, 9,9-bis(4-hydroxyphenyl)fluorene, 9,9-bis(4-hydroxy-3-methylphenyl)fluorene, 1,1-bis(4-hydroxyphenyl)cyclohexane, 1,1-bis(4-hydroxyphenyl)cyclopentane, 4,4′-dihydroxydiphenyl ether, 4,4′-dihydroxy-3,3′-dimethyl diphenyl ether, 4,4′-sulfonyldiphenol, 4,4′-dihydroxydiphenyl sulfoxide, 4,4′-dihydroxydiphenyl sulfide, 2,2′-dimethyl-4,4′-sulfonyldiphenol, 4,4′-dihydroxy-3,3′-dimethyldiphenyl sulfoxide, 4,4′-dihydroxy-3,3′-dimethyldiphenyl sulfide, 2,2′-diphenyl-4,4′-sulfonyldiphenol, 4,4′-dihydroxy-3,3′-diphenyldiphenyl sulfoxide, 4,4′-dihydroxy-3,3′-diphenyldiphenyl sulfide, 1,3-bis{2-(4-hydroxyphenyl)propyl}benzene, 1,4-bis{2-(4-hydroxyphenyl)propyl}benzene, 1,4-bis(4-hydroxyphenyl)cyclohexane, 1,3-bis(4-hydroxyphenyl)cyclohexane, 4,8-bis(4-hydroxyphenyl)tricyclo[5.2.1.02, 6]decane, 4,4′-(1,3-adamantanediyl)diphenol, and 1,3-bis(4-hydroxyphenyl)-5,7-dimethyladamantane.

Among these, preferred are 1,1-bis(4-hydroxyphenyl)-1-phenylethane, 2,2-bis(4-hydroxyphenyl)propane, 2,2-bis(4-hydroxy-3-methylphenyl)propane, 1,1-bis(4-hydroxyphenyl)cyclohexane, 1,1-bis(4-hydroxyphenyl)-3,3,5-trimethylcyclohexane, 4,4′-sulfonyldiphenol, 2,2′-dimethyl-4,4′-sulfonyldiphenol, 9,9-bis(4-hydroxy-3-methylphenyl)fluorene, 1,3-bis{2-(4-hydroxyphenyl)propyl}benzene, and 1,4-bis{2-(4-hydroxyphenyl)propyl}benzene, and especially preferred are 2,2-bis(4-hydroxyphenyl)propane, 1,1-bis(4-hydroxyphenyl)cyclohexane, 4,4′-sulfonyldiphenol, and 9,9-bis(4-hydroxy-3-methylphenyl)fluorene. Of these, most preferred is 2,2-bis(4-hydroxyphenyl)propane which has excellent strength and excellent durability. These may be used individually or in combination.

In the carbonate constitutional unit represented by the general formula [3] above, each of R³, R⁴, R⁵, R⁶, R⁷, and R⁸ is independently a hydrogen atom, an alkyl group having 1 to 12 carbon atoms, or a substituted or unsubstituted aryl group having 6 to 12 carbon atoms, preferably a hydrogen atom, an alkyl group having 1 to 6 carbon atoms, or a substituted or unsubstituted aryl group having 6 to 12 carbon atoms, especially preferably a hydrogen atom, an alkyl group having 1 to 6 carbon atoms, or a phenyl group. Each of R⁹ and R¹⁸ is independently a hydrogen atom, a halogen atom, an alkyl group having 1 to 10 carbon atoms, or an alkoxy group having 1 to 10 carbon atoms, preferably a hydrogen atom or an alkyl group having 1 to 10 carbon atoms, especially preferably a hydrogen atom or an alkyl group having 1 to 4 carbon atoms. With respect to the dihydroxyaryl-terminal polydiorganosiloxane (II) that derives the carbonate constitutional unit represented by the formula [3] above, for example, compounds represented by the following general formula (I) are preferably used.

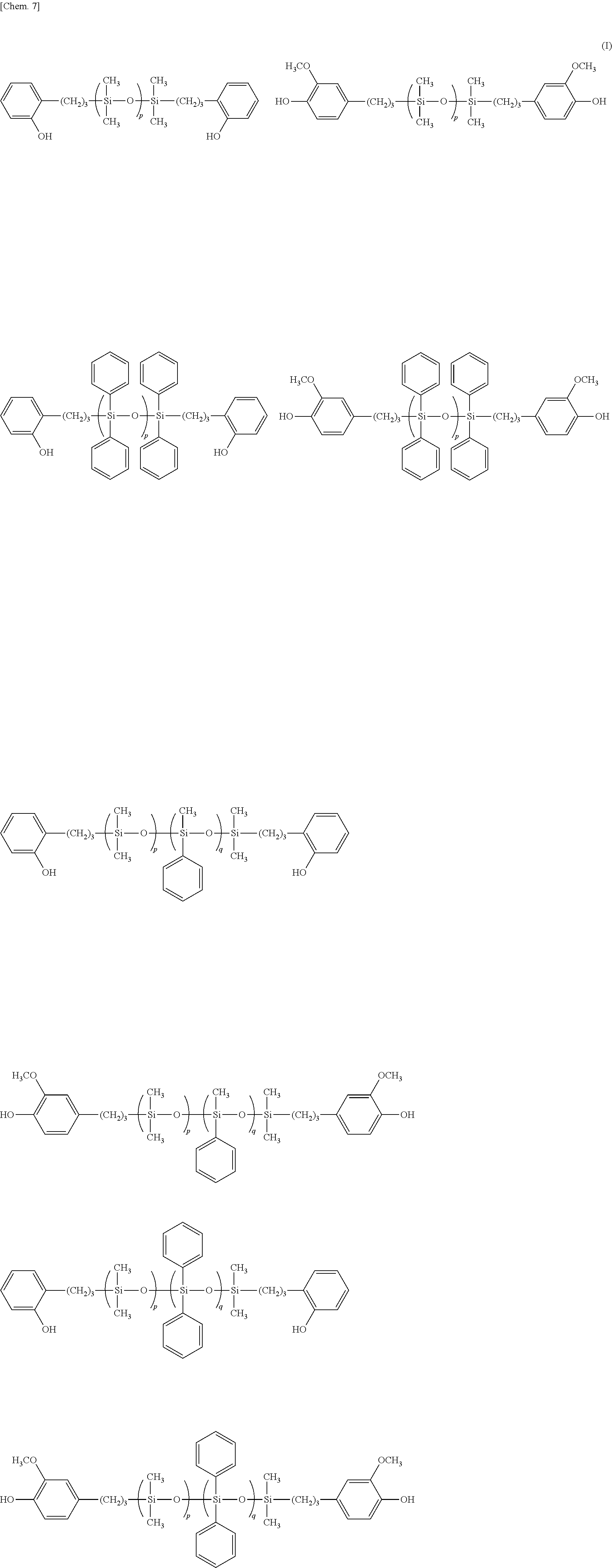

p, which indicates a diorganosiloxane polymerization degree, is a natural number, q is 0 or a natural number, and p+q is a natural number of 30 to 60, preferably 30 to 50, more preferably 35 to 50. When p+q is less than 30, it is likely that the low-temperature impact resistance and durability are poor, and, when p+q is more than 60, it is likely that the flame retardancy becomes poor.

The amount of the polydiorganosiloxane block represented by the general formula [4] below, which is contained in the general formula [3] above in the invention, is preferably 1.0 to 10.0% by weight, more preferably 2.0 to 10.0% by weight, further preferably 2.0 to 8.0% by weight, especially preferably 3.0 to 8.0% by weight, based on the weight of the polycarbonate resin composition. When the polydiorganosiloxane component amount is less than 1.0% by weight, it is likely that the low-temperature impact resistance and durability are unsatisfactory, and, when the polydiorganosiloxane component amount is more than 10.0% by weight, it is likely that an article obtained by molding has poor appearance or the temperature for heat resistance is lowered. The diorganosiloxane polymerization degree and the content of polydiorganosiloxane component can be determined by ¹H-NMR measurement.

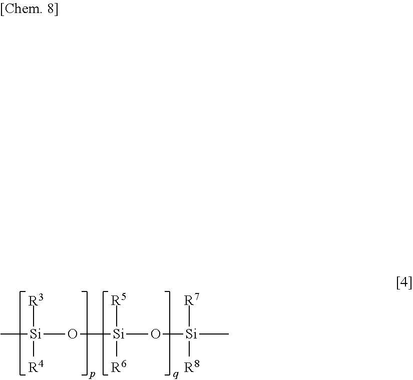

wherein, in the general formula [4], each of R³, R⁴, R⁵, R⁶, R⁷, and R⁸ is independently a hydrogen atom, an alkyl group having 1 to 12 carbon atoms, or a substituted or unsubstituted aryl group having 6 to 12 carbon atoms, p is a natural number, q is 0 or a natural number, and p+q is a natural number of 30 to 60.

It is preferred that the polycarbonate-polydiorganosiloxane copolymer used as the component A in the invention is a polycarbonate-polydiorganosiloxane copolymer which has an aggregate structure in which polydiorganosiloxane domains are dispersed in a polycarbonate matrix, in which the polydiorganosiloxane domains have an average size of 5 to 15 nm. The average size of the polydiorganosiloxane domains is more preferably 5 to 12 nm, further preferably 8 to 12 nm. When the average size of the polydiorganosiloxane domains is less than 5 nm, it is likely that the low-temperature impact resistance is unsatisfactory, and, when the average size is more than 15 nm, it is likely that an article obtained by molding has poor appearance.

The standardized dispersion of the polydiorganosiloxane domain size is preferably 25% or less, more preferably 23% or less, further preferably 20% or less. The lower limit of the standardized dispersion is preferably 5% or more from a practical point of view, more preferably 10% or more. When the polydiorganosiloxane domains have such an appropriate average size and the standardized dispersion thereof, the impact resistance and flame retardancy are likely to be improved.

With respect to the polycarbonate-polydiorganosiloxane copolymer used as the component A in the invention, a molded article having a thickness of 2.0 mm, which is formed from the polycarbonate-polydiorganosiloxane copolymer by injection molding, preferably has a total light transmittance of 88% or more. The total light transmittance is more preferably 88.5% or more, further preferably 89% or more. On the other hand, the upper limit of the total light transmittance is preferably 92%, more preferably 91.5%. When the total light transmittance is less than 88%, it is likely that the resultant resin composition has poor coloring properties.

With respect to the polycarbonate-polydiorganosiloxane copolymer, the average size of the polydiorganosiloxane domains and the standardized dispersion are evaluated by a small angle X-ray scattering (SAXS) method. The small angle X-ray scattering method is a method of measuring diffuse scattering or diffraction caused in the small angle region where the scattering angle (2θ) is in the range of less than 10°. In the small angle X-ray scattering method, with respect to a substance which has regions having a size of about 1 to 100 nm and having different electron densities, diffuse scattering of an X-ray is measured due to an electron density difference. A particle diameter of the object to be measured is determined based on the scattering angle and scattering intensity. In the case of the polycarbonate-polydiorganosiloxane copolymer resin having an aggregate structure in which polydiorganosiloxane domains are dispersed in a polycarbonate-polydiorganosiloxane copolymer matrix, diffuse scattering of an X-ray is caused due to an electron density difference between the polycarbonate matrix and the polydiorganosiloxane domains. A scattering intensity I is measured at each of scattering angles (2θ) in the range of less than 10° to measure a small angle X-ray scattering profile, and, on the assumption that the polydiorganosiloxane domains are spherical domains and there is a dispersion in the particle size distribution, simulation is conducted from a provisional particle diameter and provisional particle size distribution model using commercially available analysis software, determining an average size of the polydiorganosiloxane domains and particle size distribution (standardized dispersion). By the small angle X-ray scattering method, an average size of the polydiorganosiloxane domains dispersed in a polycarbonate polymer matrix and particle size distribution, which cannot be accurately measured by examination under a transmission electron microscope, can be measured easily with high accuracy and high reproducibility.

The average domain size means a number average of sizes of the individual domains. The standardized dispersion means a parameter obtained by standardizing the dispersion of the particle size distribution by an average size. Specifically, the standardized dispersion is a value obtained by standardizing the dispersion of the polydiorganosiloxane domain size by an average domain size, and represented by the following formula (1).

[Math. 1]

Standardized dispersion (%)=δ/Dₐᵥ (1)

In the formula (1) above, δ is a standard deviation of the polydiorganosiloxane domain size, and Dav is an average domain size.

The terms “average domain size” and “standardized dispersion” used in connection with the invention indicate measured values obtained by conducting the measurement by a small angle X-ray scattering method using a molded article having a thickness of 1.0 mm, which is formed by injection molding. Specifically, the values are obtained by measuring an average size and particle size distribution (standardized dispersion) of the polydiorganosiloxane domains by a small angle X-ray scattering method using a three-step plate (width: 50 mm; length: 90 mm; thickness is, from the gate side, 3.0 mm (length: 20 mm), 2.0 mm (length: 45 mm), and 1.0 mm (length: 25 mm); arithmetic average roughness (Ra) of the surface: 0.03 μm) which is formed by injection molding, in which the measurement is made with respect to the intersection of 5 mm from the end and 5 mm from the side of the 1.0 mm-thick portion of the plate.

Next, a method for producing the polycarbonate-polydiorganosiloxane copolymer is described below. In a preliminarily prepared mixture of an organic solvent, which is insoluble in water, and an aqueous alkali solution, a dihydric phenol (I) and a chloroformate forming compound, such as phosgene or a chloroformate of the dihydric phenol (I), are reacted with each other to prepare a mixture solution of a chloroformate compound containing a chloroformate of the dihydric phenol (I) and/or a carbonate oligomer of the dihydric phenol (I) having a terminal chloroformate group. The chloroformate forming compound is preferably phosgene.

In the formation of a chloroformate compound from the dihydric phenol (I), a chloroformate compound may be formed from all of the dihydric phenol (I) that derives the carbonate constitutional unit represented by the general formula [1] above, or part of the dihydric phenol (I) may be added as a post-addition monomer in the subsequent interfacial polycondensation reaction so that the monomer is used as a raw material for the reaction. The post-addition monomer is added for rapidly advancing the subsequent polycondensation reaction, and it is not necessary to add such a post-addition monomer. With respect to the method for the chloroformate compound formation reaction, there is no particular limitation, but generally, preferred is a method in which the reaction is conducted in a solvent in the presence of an acid binder. Further, if desired, an antioxidant, such as sodium sulfite or hydrosulfide, may be added in a small amount, and is preferably added. The amount of the chloroformate forming compound used may be appropriately selected, taking the stoichiometric ratio for the reaction (equivalent amount) into consideration. Further, when using phosgene which is a preferred chloroformate forming compound, a method of blowing gasified phosgene into the reaction system can be preferably employed.

As the acid binder, for example, an alkali metal hydroxide, such as sodium hydroxide or potassium hydroxide, an alkali metal carbonate, such as sodium carbonate or potassium carbonate, an organic base, such as pyridine, or a mixture thereof is used.

The amount of the acid binder used may be similarly appropriately selected, taking the stoichiometric ratio for the reaction (equivalent amount) into consideration. Specifically, it is preferred that the acid binder is used in an amount of 2 equivalent per 1 mol of the dihydric phenol (I) used for forming a chloroformate compound of the dihydric phenol (I) (generally 1 mol corresponds to 2 equivalent), or in an amount slightly larger than that amount.

With respect to the solvent, solvents inert to various reactions, such as those used in the production of a conventionally known polycarbonate, may be used individually or in combination as a mixed solvent. Typical examples of solvents include hydrocarbon solvents, such as xylene, and halogenated hydrocarbon solvents, such as methylene chloride and chlorobenzene. Particularly, a halogenated hydrocarbon solvent, such as methylene chloride, is preferably used.

With respect to the pressure for the chloroformate compound formation reaction, there is no particular limitation, and the reaction may be conducted under any of atmospheric pressure, a certain pressure, and a reduced pressure, but generally the reaction is advantageously conducted under atmospheric pressure. The reaction temperature is selected from those in the range of from −20 to 50° C., and, in many cases, the reaction causes heat generation, and therefore it is desired that the reaction system is cooled with water or ice. The reaction time varies depending on other conditions and therefore cannot be strictly defined, but the reaction is generally conducted for 0.2 to 10 hours.

With respect to the pH range for the chloroformate compound formation reaction, conventionally known conditions for interfacial reaction can be used, and the pH is generally adjusted to 10 or more.

In the production of the polycarbonate-polydiorganosiloxane copolymer used as the component A in the present invention, a mixture solution of a chloroformate compound containing a chloroformate of the dihydric phenol (I) and a carbonate oligomer of the dihydric phenol (I) having a terminal chloroformate group is prepared as mentioned above, and then, while stirring the mixture solution, the dihydroxyaryl-terminal polydiorganosiloxane that derives the carbonate constitutional unit represented by the general formula [2] is added at a rate of 0.01 mol/min or less per 1 mol of the dihydric phenol (I) charged for the preparation of the mixture solution to cause the dihydroxyaryl-terminal polydiorganosiloxane and the chloroformate compound to undergo interfacial polycondensation, obtaining a polycarbonate-polydiorganosiloxane copolymer.

With respect to the polycarbonate-polydiorganosiloxane copolymer used as the component A in the invention, a branched polycarbonate-polydiorganosiloxane copolymer can be obtained from the copolymer by using a branching agent and a dihydric phenol compound in combination. With respect to the trifunctional or multifunctional aromatic compound used in the branched polycarbonate resin, examples of the compounds include trisphenols, such as phloroglucinol, phloroglucide, 4,6-dimethyl-2,4,6-tris(4-hydroxyphenyl)heptene-2,2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol, and 4-{4-[1,1-bis(4-hydroxyphenyl)ethyl]benzene}-α,α-dimethylbenzylphenol, tetra(4-hydroxyphenyl)methane, bis(2,4-dihydroxyphenyl) ketone, 1,4-bis(4,4-dihydroxytriphenylmethyl)benzene, trimellitic acid, pyromellitic acid, benzophenonetetracarboxylic acid, and acid chlorides thereof, and, of these, preferred are 1,1,1-tris(4-hydroxyphenyl)ethane and 1,1,1-tris(3,5-dimethyl-4-hydroxyphenyl)ethane, and especially preferred is 1,1,1-tris(4-hydroxyphenyl)ethane.

The method for producing the branched polycarbonate-polydiorganosiloxane copolymer may be a method in which a branching agent is contained in the mixture solution for the chloroformate compound formation reaction, or a method in which a branching agent is added during the interfacial polycondensation reaction after completion of the formation reaction. The amount of the carbonate constitutional units derived from the branching agent is preferably 0.005 to 1.5 mol %, more preferably 0.01 to 1.2 mol %, especially preferably 0.05 to 1.0 mol %, based on the total of the carbonate constitutional units constituting the copolymer. The amount of the branched structure can be determined by ¹H-NMR measurement.

With respect to the pressure in the system for the polycondensation reaction, the reaction can be conducted under any of a reduced pressure, atmospheric pressure, and a certain pressure, but generally can be preferably conducted under atmospheric pressure or under the pressure in the reaction system. The reaction temperature is selected from those in the range of from −20 to 50° C., and, in many cases, the polymerization causes heat generation, and therefore it is desired that the reaction system is cooled with water or ice. The reaction time varies depending on other conditions, such as a reaction temperature, and therefore cannot be strictly defined, but the reaction is generally conducted for 0.5 to 10 hours. The obtained polycarbonate-polydiorganosiloxane copolymer can be optionally subjected to appropriate physical treatment (such as mixing or fractionation) and/or chemical treatment (such as polymer reaction, crosslinking treatment, or partial decomposition treatment), obtaining a polycarbonate-polydiorganosiloxane copolymer having a desired reduced viscosity [n s p/c]. The obtained reaction product (crude product) can be subjected to various after-treatments, such as a conventionally known separation and purification method, recovering a polycarbonate-polydiorganosiloxane copolymer having a desired purity (purification degree).

The polycarbonate-polydiorganosiloxane copolymer used as the component A in the invention has a viscosity average molecular weight (Mv (component A)) of 23,000 to 30,000, preferably 23,000 to 28,000, more preferably in the range of from 23,000 to 27,000, further preferably in the range of from 23,000 to 25,000. When the molecular weight of the copolymer is more than 30,000, the melt viscosity becomes such high that only poor moldability is obtained, and, when the molecular weight of the copolymer is less than 23,000, excellent mechanical properties cannot be obtained.

A viscosity average molecular weight of the polycarbonate-polydiorganosiloxane copolymer used as the component A in the invention is determined as follows. First, a specific viscosity (ηₛₚ) at 20° C., which is calculated from the following formula, is determined using an Ostwald viscometer with respect to a solution obtained by dissolving 0.7 g of the polycarbonate-polydiorganosiloxane copolymer resin in 100 ml of methylene chloride,

Specific viscosity(ηₛₚ)=(t−t₀)/t₀

[wherein t₀ is the duration (seconds) of falling of methylene chloride, and t is the duration (seconds) of falling of a sample solution]
and, from the determined specific viscosity (ηₛₚ), a viscosity average molecular weight Mv is determined by calculation using the following mathematical formula.
ηₛₚ/c=[η]+0.45^{×[η]2}c (wherein [η] is an intrinsic viscosity)
[η]=1.23×10⁻⁴MV^{0.83}
c=0.7

The amount of the component A contained is, relative to 100 parts by weight of the resin component, 10 to 90 parts by weight, preferably 20 to 80 parts by weight, more preferably 25 to 75 parts by weight. When the amount of the component A contained is less than 10 parts by weight, satisfactory room-temperature impact resistance and low-temperature impact resistance cannot be obtained, and, when the amount of the component A contained is more than 90 parts by weight, the retention of physical properties after the water exposure becomes poor.

### (Component B: Polycarbonate Resin)

The polycarbonate resin used as the component B in the invention is obtained by reacting a dihydric phenol and a carbonate precursor. Examples of methods for reaction include an interfacial polymerization method, a melt transesterification method, a solid phase transesterification method for a carbonate prepolymer, and a ring-opening polymerization method for a cyclic carbonate compound.

Typical examples of the dihydric phenols used in the invention include hydroquinone, resorcinol, 4,4′-biphenol, 1,1-bis(4-hydroxyphenyl)ethane, 2,2-bis(4-hydroxyphenyl)propane (generally called bisphenol A), 2,2-bis(4-hydroxy-3-methylphenyl)propane, 2,2-bis(4-hydroxyphenyl)butane, 1,1-bis(4-hydroxyphenyl)-1-phenylethane, 1,1-bis(4-hydroxyphenyl)cyclohexane, 1,1-bis(4-hydroxyphenyl)-3,3,5-trimethylcyclohexane, 2,2-bis(4-hydroxyphenyl)pentane, 4,4′-(p-phenylenediisopropylidene)diphenol, 4,4′-(m-phenylenediisopropylidene)diphenol, 1,1-bis(4-hydroxyphenyl)-4-isopropylcyclohexane, bis(4-hydroxyphenyl) oxide, bis(4-hydroxyphenyl) sulfide, bis(4-hydroxyphenyl) sulfoxide, bis(4-hydroxyphenyl) sulfone, bis(4-hydroxyphenyl) ketone, bis(4-hydroxyphenyl) ester, bis(4-hydroxy-3-methylphenyl) sulfide, 9,9-bis(4-hydroxyphenyl)fluorene, and 9,9-bis(4-hydroxy-3-methylphenyl)fluorene. Preferred dihydric phenol is a bis(4-hydroxyphenyl)alkane, and, particularly in view of the impact resistance, bisphenol A is especially preferred and generally used.

In the invention, as a polycarbonate other than the bisphenol A polycarbonate which is a general-purpose polycarbonate, a special polycarbonate produced using another dihydric phenol can be used as the component B.

For example, a polycarbonate (homopolymer or copolymer) using, as part of or all of the dihydric phenol component, 4,4′-(m-phenylenediisopropylidene)diphenol (hereinafter, frequently referred to simply as “BPM”), 1,1-bis(4-hydroxyphenyl)cyclohexane, 1,1-bis(4-hydroxyphenyl)-3,3,5-trimethylcyclohexane (hereinafter, frequently referred to simply as “Bis-TMC”), 9,9-bis(4-hydroxyphenyl)fluorene, or 9,9-bis(4-hydroxy-3-methylphenyl)fluorene (hereinafter, frequently referred to simply as “BCF”) is suitable for the application that especially strongly requires stability for a dimensional change due to absorbing water and form stability. The dihydric phenol other than BPA is preferably used in an amount of 5 mol % or more, particularly 10 mol % or more, of the whole of the dihydric phenol component constituting the polycarbonate.

Particularly, when high stiffness and more excellent hydrolytic resistance are required, it is especially preferred that the component B constituting the resin composition is the following copolymer polycarbonates (1) to (3):
(1) a copolymer polycarbonate in which the amount of BPM is 20 to 80 mol % (more preferably 40 to 75 mol %, further preferably 45 to 65 mol %), and the amount of BCF is 20 to 80 mol % (more preferably 25 to 60 mol %, further preferably 35 to 55 mol %), based on 100 mol % of the dihydric phenol component constituting the polycarbonate;
(2) a copolymer polycarbonate in which the amount of BPA is 10 to 95 mol % (more preferably 50 to 90 mol %, further preferably 60 to 85 mol %), and the amount of BCF is 5 to 90 mol % (more preferably 10 to 50 mol %, further preferably 15 to 40 mol %), based on 100 mol % of the dihydric phenol component constituting the polycarbonate;
(3) a copolymer polycarbonate in which the amount of BPM is 20 to 80 mol % (more preferably 40 to 75 mol %, further preferably 45 to 65 mol %), and the amount of Bis-TMC is 20 to 80 mol % (more preferably 25 to 60 mol %, further preferably 35 to 55 mol %), based on 100 mol % of the dihydric phenol component constituting the polycarbonate.

These special polycarbonates may be used individually or appropriately in combination. Further, the special polycarbonate(s) and a general-purpose bisphenol A polycarbonate can be used in combination.

The methods for producing the special polycarbonates and the properties of the polycarbonates are described in detail in, for example, JPH06−172508A, JPH08−27370A, JP2001−55435A, and JP2002−117580A.

Among the above-mentioned polycarbonates, the polycarbonate which has the copolymerization composition or the like controlled so as to have a water absorption and a Tg (glass transition temperature) in their respective ranges shown below has excellent hydrolytic resistance as a polymer, and further exhibits extremely excellent warpage resistance after molded, and therefore is especially preferably used in the field that requires form stability:
(i) a polycarbonate having a water absorption of 0.05 to 0.15%, preferably 0.06 to 0.13%, and having a Tg of 120 to 180° C.; or
(ii) a polycarbonate having a Tg of 160 to 250° C., preferably 170 to 230° C., and having a water absorption of 0.10 to 0.30%, preferably 0.13 to 0.30%, more preferably 0.14 to 0.27%.

The water absorption of the polycarbonate is a value obtained using a test specimen having a disc form having a diameter of 45 mm and a thickness of 3.0 mm in accordance with ISO62−1980 by immersing the specimen in water at 23° C. for 24 hours and then measuring a water content of the resultant specimen. Further, the Tg (glass transition temperature) is a value determined by measurement using a differential scanning calorimeter (DSC) in accordance with JIS K7121.

With respect to the carbonate precursor, a carbonyl halide, a carbonic acid diester, a haloformate, or the like is used, and specific examples include phosgene, diphenyl carbonate, and a dihaloformate of dihydric phenol.

When the polycarbonate resin is produced from the above-mentioned dihydric phenol and carbonate precursor by an interfacial polymerization method, if necessary, a catalyst, a chain terminator, an antioxidant for preventing the dihydric phenol from being oxidized, or the like may be used. The polycarbonate resin in the invention includes a branched polycarbonate resin obtained by copolymerizing a trifunctional or multifunctional aromatic compound, a polyester carbonate resin obtained by copolymerizing an aromatic or aliphatic (including alicyclic) bifunctional carboxylic acid, a copolymerized polycarbonate resin obtained by copolymerizing a bifunctional alcohol (including alicyclic), and a polyester carbonate resin obtained by copolymerizing the above bifunctional carboxylic acid and bifunctional alcohol. The polycarbonate resin in the invention may be a mixture of two or more types of the obtained polycarbonate resins.

The branched polycarbonate resin can impart anti-dripping performance and the like to the resin composition of the invention. With respect to the trifunctional or multifunctional aromatic compound used in the branched polycarbonate resin, examples of the compounds include trisphenols, such as phloroglucinol, phloroglucide, 4,6-dimethyl-2,4,6-tris(4-hydroxyphenyl)heptene-2,2,4,6-trimethyl-2,4,6-tris(4-hydroxyphenyl)heptane, 1,3,5-tris(4-hydroxyphenyl)benzene, 1,1,1-tris(4-hydroxyphenyl)ethane, 1,1,1-tris(3,5-dimethyl-4-hydroxyphenyl)ethane, 2,6-bis(2-hydroxy-5-methylbenzyl)-4-methylphenol, and 4-{4-[1,1-bis(4-hydroxyphenyl)ethyl]benzene}-α,α-dimethylbenzylphenol, tetra(4-hydroxyphenyl)methane, bis(2,4-dihydroxyphenyl) ketone, 1,4-bis(4,4-dihydroxytriphenylmethyl)benzene, trimellitic acid, pyromellitic acid, benzophenonetetracarboxylic acid, and acid chlorides thereof, and, of these, preferred are 1,1,1-tris(4-hydroxyphenyl)ethane and 1,1,1-tris(3,5-dimethyl-4-hydroxyphenyl)ethane, and especially preferred is 1,1,1-tris(4-hydroxyphenyl)ethane.

In the branched polycarbonate, the amount of the constitutional units derived from the multifunctional aromatic compound in the total (100 mol %) of the constitutional units derived from the dihydric phenol and the constitutional units derived from the multifunctional aromatic compound is preferably 0.01 to 1 mol %, more preferably 0.05 to 0.9 mol %, further preferably 0.05 to 0.8 mol %.

Particularly, in the case of a melt transesterification method, a side reaction may occur to cause branched structural units, and the amount of such branched structural units in the total (100 mol %) of the branched structural units and the constitutional units derived from the dihydric phenol is preferably 0.001 to 1 mol %, more preferably 0.005 to 0.9 mol %, further preferably 0.01 to 0.8 mol %. The proportion of the branched structure can be determined by ¹H-NMR measurement.

The aliphatic bifunctional carboxylic acid is preferably an α, ω)-dicarboxylic acid. Preferred examples of aliphatic bifunctional carboxylic acids include linear saturated aliphatic dicarboxylic acids, such as sebacic acid (decanedioic acid), dodecanedioic acid, tetradecanedioic acid, octadecanedioic acid, and icosanedioic acid, and alicyclic dicarboxylic acids, such as cyclohexanedicarboxylic acid. The bifunctional alcohol is more preferably an alicyclic diol, and examples include cyclohexanedimethanol, cyclohexanediol, and tricyclodecanedimethanol.

Reaction methods including an interfacial polymerization method, a melt transesterification method, a solid phase transesterification method for a carbonate prepolymer, and a ring-opening polymerization method for a cyclic carbonate compound, which are the method for producing the polycarbonate resin in the invention, are well-known methods through various types of documents and published patent documents and the like.

The polycarbonate resin used as the component B in the invention preferably has a viscosity average molecular weight (Mv (component B)) in the range of 15,000 to 30,000, more preferably 16,000 to 28,000, especially preferably in the range of 18,000 to 25,000. When the molecular weight of the polycarbonate resin is more than 30,000, it is likely that the melt viscosity becomes too high, resulting in poor moldability, and, when the molecular weight of the polycarbonate resin is less than 15,000, it is likely that excellent mechanical properties cannot be obtained. With respect to the resin component in the invention, the ratio of the viscosity average molecular weight of the component A to that of the component B (Mv (component A)/Mv (component B)) is 1 to 1.5, preferably 1 to 1.3, more preferably 1 to 1.25. When the ratio of the viscosity average molecular weight of the component A to that of the component B is less than 1, the flame retardancy and the flame retardancy after the water exposure become poor. When the ratio is more than 1.5, the low-temperature impact resistance and the retention of physical properties after the water exposure become poor.

### (Component C: Phosphazene Compound)

The resin composition of the invention contains a phosphazene compound as the component C. The phosphazene contains a phosphorus atom and a nitrogen atom in the molecule thereof, and therefore can impart an effect of suppressing durability lowering and flame retardancy to the resin composition. When a compound other than the phosphazene, such as a phosphate or a condensed phosphate, is used as a flame retardant, the polycarbonate resin is plasticized to cause a lowering of the durability and a lowering of the flame retardancy. With respect to the phosphazene, there is no particular limitation as long as it is a compound containing no halogen atom and having a phosphazene structure in the molecule thereof. The above-mentioned phosphazene structure means a structure represented by the formula: —P(R)═N—[wherein R is an organic group]. The phosphazene compound is represented by the following general formula [5] or [6]:

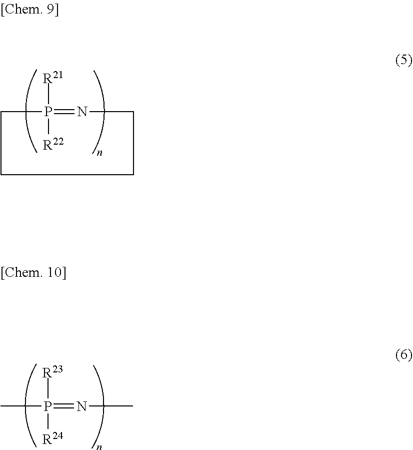

wherein R²¹, R²², R²³, and R²⁴ represent hydrogen, a hydroxyl group, an amino group, or an organic group containing no halogen atom, and n represents an integer of 3 to 10.

Examples of the organic groups containing no halogen atom, which are represented by R²¹, R²², R²³, and R²⁴ in the formulae [5] and [6] above, include an alkoxy group, a phenyl group, an amino group, and an allyl group.

Especially, preferred is a cyclic phenoxyphosphazene represented by the following general formula [7]:

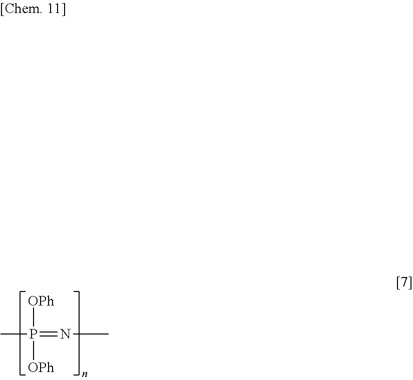

wherein n represents an integer of 3 to 25, and Ph represents a phenyl group.

It is preferred that the phosphazene which is the component C contains a phosphazene cyclic trimer (n=3) in an amount of 98.5 mol % or more. The content of the phosphazene cyclic trimer is preferably 99 to 100 mol %, more preferably in the range of 99.5 to 100 mol %. When the content of the phosphazene cyclic trimer is less than 98.5 mol %, it is likely that the durability and flame retardancy are poor.

A general method for producing a phosphazene is descried in, for example, EP728811A and WO97/40092.

In the process of the production, the phosphazene cyclic trimer as well as a cyclic tetramer or a higher oligomer as a by-product are formed, but purification by column chromatography or the like can increase the content of the phosphazene cyclic trimer.

The content of the phosphazene cyclic trimer in the phosphazene can be quantitatively determined by 31 P NMR (chemical shift: δ trimer: 6.5 to 10.0 ppm; δ tetramer: −10 to −13.5 ppm; oligomer higher than δ: −16.5 to −25.0 ppm).

The amount of the component C contained is, relative to 100 parts by weight of the resin component, 0.5 to 7 parts by weight, preferably 0.7 to 5 parts by weight, more preferably 1 to 3.5 parts by weight. When the amount of the component C contained is less than 0.5 parts by weight, an flame retardancy effect cannot be obtained, and, when the amount of the component C contained is more than 7 parts by weight, the retention of physical properties after the water exposure and the low-temperature impact resistance become poor.

### (Component D: Fluorine-Containing Anti-Dripping Agent)

The resin composition of the invention contains a fluorine-containing anti-dripping agent as the component D. By virtue of the fluorine-containing anti-dripping agent contained in the resin composition, excellent flame retardancy can be achieved without lowering the physical properties of a molded article obtained from the composition.

As an example of the fluorine-containing anti-dripping agent, there can be mentioned a fluorine-containing polymer having fibril forming ability, and examples of such polymers include polytetrafluoroethylene, a tetrafluoroethylene copolymer (e.g., a tetrafluoroethylene/hexafluoropropylene copolymer), the partially fluorinated polymer shown in US4,379,910B, and a polycarbonate resin produced from fluorinated diphenol. Of these, preferred is polytetrafluoroethylene (hereinafter, frequently referred to as “PTFE”).

The PTFE having fibril forming ability has an extremely high molecular weight, and has a tendency that PTFE is bonded together due to an external action, such as shearing force, to be in a fiber form. The molecular weight of PTFE, in terms of a number average molecular weight determined from the standard specific gravity, is 1,000,000 to 10,000,000, more preferably 2,000,000 to 9,000,000. The PTFE can be used in the form of a solid or in the form of an aqueous dispersion. Further, with respect to the PTFE having fibril forming ability, for improving the dispersibility in the resin and obtaining further excellent flame retardancy and mechanical properties, a PTFE mixture which is in the form of a mixture of PTFE with another resin can be used.

Examples of commercially available products of the PTFE having fibril forming ability include Teflon (registered trademark) 6J of DuPont-Mitsui Fluorochemicals Co., Ltd., and Polyflon MPA FA500 and F-201L of Daikin Industries, Ltd. Typical examples of commercially available products of aqueous PTFE dispersion include Fluon AD-1, AD-936, manufactured by Asahi-ICI Fluoropolymers Co., Ltd., Fluon D-1 and D-2, manufactured by Daikin Industries, Ltd, and Teflon (registered trademark) 30J, manufactured by DuPont-Mitsui Fluorochemicals Co., Ltd.

With respect to the PTFE in the mixture form, there can be used one which is obtained by: (1) a method in which an aqueous dispersion of PTFE and an aqueous dispersion or solution of an organic polymer are mixed and subjected to coprecipitation to obtain a coaggregation mixture (method described in JPS60−258263A, JPS63−154744A and the like); (2) a method in which an aqueous dispersion of PTFE and dried organic polymer particles are mixed with each other (method described in JPH04−272957A); (3) a method in which an aqueous dispersion of PTFE and an organic polymer particle solution are uniformly mixed with each other, and, from the resultant mixture, the both media are simultaneously removed (method described in JPH06−220210A, JPH08−188653A and the like); (4) a method in which a monomer for forming an organic polymer is subjected to polymerization in an aqueous dispersion of PTFE (method described in JPH09−95583A); or (5) a method in which an aqueous dispersion of PTFE and an organic polymer dispersion are uniformly mixed with each other, and then a vinyl monomer is subjected to polymerization in the mixed dispersion, obtaining a mixture (method described in JPH11-29679A and the like). Examples of commercially available products of the PTFE in the mixture form include “METABLEN A3800” (trade name) of Mitsubishi Rayon Co., Ltd., and “BLENDEX B449” (trade name), manufactured by GE Specialty Chemicals, Inc.

With respect to the proportion of PTFE in the PTFE mixture (100% by weight) is preferably 1 to 60% by weight, more preferably 5 to 55% by weight. When the proportion of PTFE is in the above range, excellent dispersibility of PTFE can be achieved. The amount of the component D contained indicates the net amount of the anti-dripping agent, and, in the case of PTFE in the mixture form, the amount indicates the net amount of PTFE.

The amount of the component D contained is, relative to 100 parts by weight of the resin component, 0.1 to 0.5 parts by weight, preferably 0.1 to 0.3 parts by weight, more preferably 0.1 to 0.2 parts by weight. When the amount of the anti-dripping agent is much smaller than the above range, the flame retardancy becomes unsatisfactory. On the other hand, when the amount of the anti-dripping agent is much larger than the above, the low-temperature impact resistance and the retention of physical properties after the water exposure become poor.

### (Other Additives)

In the resin composition of the invention, an ultraviolet light absorber, a heat stabilizer, a release agent, or the like can be further incorporated into the resin composition.

### (i) Ultraviolet Light Absorber

Specific examples of benzophenone ultraviolet light absorbers include 2,4-dihydroxybenzophenone, 2-hydroxy-4-methoxybenzophenone, 2-hydroxy-4-octoxybenzophenone, 2-hydroxy-4-benzyloxybenzophenone, 2-hydroxy-4-methoxy-5-sulfoxybenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxybenzophenone, bis(5-benzoyl-4-hydroxy-2-methoxyphenyl)methane, 2-hydroxy-4-n-dodecyloxybenzophenone, and 2-hydroxy-4-methoxy-2′-carboxybenzophenone. Specific examples of benzotriazole ultraviolet light absorbers include 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2H-benzotriazol-2-yl)phenol], 2-(2-hydroxy-3,5-di-tert-butylphenyl)benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-octylphenyl)benzotriazole, 2-(2-hydroxy-5-tert-butylphenyl)benzotriazole, 2-(2-hydroxy-4-octoxyphenyl)benzotriazole, 2,2′-methylenebis(4-cumyl-6-benzotriazolephenyl), 2,2′-p-phenylenebis(1,3-benzoxazin-4-one), 2-[2-hydroxy-3-(3,4,5,6-tetrahydrophthalimidemethyl)-5-methylphenyl]benzotriazole, and polymers having a 2-hydroxyphenyl-2H-benzotriazole skeleton, such as a copolymer of 2-(2′-hydroxy-5-methacryloxyethylphenyl)-2H-benzotriazole and a vinyl monomer copolymerizable with the monomer, and a copolymer of 2-(2′-hydroxy-5-acryloxyethylphenyl)-2H-benzotriazole and a vinyl monomer copolymerizable with the monomer. Specific examples of hydroxyphenyltriazine ultraviolet light absorbers include 2-(4,6-diphenyl-1,3,5-triazin-2-yl)-5-hexyloxyphenol, 2-(4,6-diphenyl-1,3,5-triazin-2-yl)-5-methyloxyphenol, 2-(4,6-diphenyl-1,3,5-triazin-2-yl)-5-ethyloxyphenol, 2-(4,6-diphenyl-1,3,5-triazin-2-yl)-5-propyloxyphenol, and 2-(4,6-diphenyl-1,3,5-triazin-2-yl)-5-butyloxyphenol. Further examples include compounds corresponding to the compounds mentioned above as examples, in which the phenyl group is replaced by a 2,4-dimethylphenyl group, such as 2-(4,6-bis(2,4-dimethylphenyl)-1,3,5-triazin-2-yl)-5-hexyloxyphenol. Specific examples of cyclic imino ester ultraviolet light absorbers include 2,2′-p-phenylenebis(3,1-benzoxazin-4-one), 2,2′-m-phenylenebis(3,1-benzoxazin-4-one), and 2,2′-p,p′-diphenylenebis(3,1-benzoxazin-4-one). Further, specific examples of cyanoacrylate ultraviolet light absorbers include 1,3-bis-[(2′-cyano-3′,3′-diphenylacryloyl)oxy]−2,2-bis[(2-cyano-3,3-diphenylacryloyl)oxy]methyl)propane, and 1,3-bis-[(2-cyano-3,3-diphenylacryloyl)oxy]benzene. Further, the ultraviolet light absorber may have a structure of a radically polymerizable monomer compound, and may be a polymer-type ultraviolet light absorber obtained by copolymerizing the ultraviolet light absorbing monomer and/or light-stable monomer and a monomer, such as an alkyl (meth)acrylate. Preferred examples of the ultraviolet light absorbing monomers include compounds containing in the ester substituent of the (meth)acrylate a benzotriazole skeleton, a benzophenone skeleton, a triazine skeleton, a cyclic imino ester skeleton, or a cyanoacrylate skeleton. Among those mentioned above, in view of the ultraviolet light absorbing ability, a benzotriazole ultraviolet light absorber and a hydroxyphenyltriazine ultraviolet light absorber are preferred, and, in view of the heat resistance and hue, a cyclic imino ester ultraviolet light absorber and a cyanoacrylate ultraviolet light absorber are preferred. Specifically, for example, there can be mentioned “KEMISORB 79”, manufactured by Chemipro Kasei Kaisha, Ltd., and “TINUVIN 234”, manufactured by BASF Japan Ltd. The ultraviolet light absorbers may be used individually or in combination.

The amount of the ultraviolet light absorber contained is, relative to 100 parts by weight of the resin component, preferably 0.01 to 3 parts by weight, more preferably 0.01 to 1 part by weight, further preferably 0.05 to 1 part by weight, especially preferably 0.05 to 0.5 parts by weight. When the amount of the ultraviolet light absorber contained is less than 0.01 parts by weight, it is likely that the weathering resistance is unsatisfactory, and, when the amount of the ultraviolet light absorber contained is more than 3 parts by weight, it is likely that the flame retardancy and durability are unsatisfactory.

### (ii) Heat Stabilizer

In the resin composition of the invention, a conventionally known stabilizer can be incorporated into the resin composition. Examples of stabilizers include a phosphorus stabilizer and a hindered phenol stabilizer.

(ii-i) Phosphorus Stabilizer

In the resin composition of the invention, it is preferred that a phosphorus stabilizer is incorporated into the resin composition for the purpose of improving the thermal stability during the production or molding processing to such an extent that hydrolysis is not promoted, improving the mechanical properties, hue, and molding stability. Examples of phosphorus stabilizers include phosphoric acid, phosphorous acid, hypophosphorous acid, phosphonic acid and esters thereof, and tertiary phosphine.

Specific examples of phosphate stabilizers include tributyl phosphate, trimethyl phosphate, tricresyl phosphate, triphenyl phosphate, trichlorophenyl phosphate, triethyl phosphate, diphenylcresyl phosphate, diphenylmonoorthoxenyl phosphate, tributoxyethyl phosphate, dibutyl phosphate, dioctyl phosphate, and diisopropyl phosphate.

Examples of phosphite stabilizers include triphenyl phosphite, tris(nonylphenyl) phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, 2,2-methylenebis(4,6-di-tert-butylphenyl)octyl phosphite, tris(diethylphenyl) phosphite, tris(di-isopropylphenyl) phosphite, tris(di-n-butylphenyl) phosphite, tris(2,4-di-tert-butylphenyl) phosphite, tris(2,6-di-tert-butylphenyl) phosphite, distearylpentaerythritol diphosphite, bis(2,4-di-tert-butylphenyl)pentaerythritol diphosphite, bis(2,6-di-tert-butyl-4-methylphenyl)pentaerythritol diphosphite, bis(2,6-di-tert-butyl-4-ethylphenyl)pentaerythritol diphosphite, phenylbisphenol A pentaerythritol diphosphite, bis(nonylphenyl)pentaerythritol diphosphite, and dicyclohexylpentaerythritol diphosphite.

Further, as another phosphite stabilizer, a phosphite stabilizer being capable of reacting with a dihydric phenol and having a cyclic structure can be used. Examples include 2,2′-methylenebis(4,6-di-tert-butylphenyl) (2,4-di-tert-butylphenyl) phosphite, 2,2′-methylenebis(4,6-di-tert-butylphenyl) (2-tert-butyl-4-methylphenyl) phosphite, 2,2′-methylenebis(4-methyl-6-tert-butylphenyl) (2-tert-butyl-4-methylphenyl) phosphite, and 2,2′-ethylidenebis(4-methyl-6-tert-butylphenyl) (2-tert-butyl-4-methylphenyl) phosphite.

Examples of phosphonite stabilizers include tetrakis(2,4-di-tert-butylphenyl)-4,4′-biphenylene diphosphonite, tetrakis(2,4-di-tert-butylphenyl)-4,3′-biphenylene diphosphonite, tetrakis(2,4-di-tert-butylphenyl)-3,3′-biphenylene diphosphonite, tetrakis(2,6-di-tert-butylphenyl)-4,4′-biphenylene diphosphonite, tetrakis(2,6-di-tert-butylphenyl)-4,3′-biphenylene diphosphonite, tetrakis(2,6-di-tert-butylphenyl)-3,3′-biphenylene diphosphonite, bis(2,4-di-tert-butylphenyl)-4-phenyl-phenyl phosphonite, bis(2,4-di-tert-butylphenyl)-3-phenyl-phenyl phosphonite, bis(2,6-di-n-butylphenyl)-3-phenyl-phenyl phosphonite, bis(2,6-di-tert-butylphenyl)-4-phenyl-phenyl phosphonite, and bis(2,6-di-tert-butylphenyl)-3-phenyl-phenyl phosphonite, and preferred are tetrakis(di-tert-butylphenyl)-biphenylene diphosphonite and bis(di-tert-butylphenyl)-phenyl-phenyl phosphonite, and more preferred are tetrakis(2,4-di-tert-butylphenyl)-biphenylene diphosphonite and bis(2,4-di-tert-butylphenyl)-phenyl-phenyl phosphonite. The phosphonite compound and the phosphite compound having an aryl group substituted with two or more alkyl groups can be preferably used in combination. Examples of phosphonate compounds include dimethyl benzenephosphonate, diethyl benzenephosphonate, and dipropyl benzenephosphonate.

Examples of tertiary phosphine stabilizers include triethylphosphine, tripropylphosphine, tributylphosphine, trioctylphosphine, triamylphosphine, dimethylphenylphosphine, dibutylphenylphosphine, diphenylmethylphosphine, diphenyloctylphosphine, triphenylphosphine, tri-p-tolylphosphine, trinaphthylphosphine, and diphenylbenzylphosphine. Especially preferred tertiary phosphine stabilizer is triphenylphosphine. The phosphorus stabilizers can be used individually or in combination.

(ii-ii) Hindered Phenol Stabilizer

A hindered phenol stabilizer can be further incorporated into the resin composition of the invention. The incorporation of such a stabilizer exhibits an effect such that, for example, deterioration of the hue during the molding processing or deterioration of the hue during the use for a long term is suppressed. Examples of hindered phenol stabilizers include α-tocopherol, butylhydroxytoluene, sinapyl alcohol, vitamin E, n-octadecyl-β-(4′-hydroxy-3′,5′-di-tert-butylphenyl) propionate, 2-tert-butyl-6-(3′-tert-butyl-5′-methyl-2′-hydroxybenzyl)-4-methylphenyl acrylate, 2,6-di-tert-butyl-4-(N,N-dimethylaminomethyl)phenol, 3,5-di-tert-butyl-4-hydroxybenzylphosphonate diethyl ester, 2,2′-methylenebis(4-methyl-6-tert-butylphenol), 2,2′-methylenebis(4-ethyl-6-tert-butylphenol), 4,4′-methylenebis(2,6-di-tert-butylphenol), 2,2′-methylenebis(4-methyl-6-cyclohexylphenol), 2,2′-dimethylene-bis(6-α-methyl-benzyl-p-cresol)2,2′-ethylidene-bis(4,6-di-tert-butylphenol), 2,2′-butylidene-bis(4-methyl-6-tert-butylphenol), 4,4′-butylidenebis(3-methyl-6-tert-butylphenol), triethylene glycol-N-bis-3-(3-tert-butyl-4-hydroxy-5-methylphenyl) propionate, 1,6-hexanediolbis[3-(3,5-di-tert-butyl-4-hydroxyphenyl) propionate], bis[2-tert-butyl-4-methyl6-(3-tert-butyl-5-methyl-2-hydroxybenzyl)phenyl] terephthalate, 3,9-bis{2-[3-(3-tert-butyl-4-hydroxy-5-methylphenyl)propionyloxy]-1,1,-dimethylethyl}−2,4,8,10-tetraoxaspiro[5,5]undecane, 4,4′-thiobis(6-tert-butyl-m-cresol), 4,4′-thiobis(3-methyl-6-tert-butylphenol), 2,2′-thiobis(4-methyl-6-tert-butylphenol), bis(3,5-di-tert-butyl-4-hydroxybenzyl) sulfide, 4,4′-di-thiobis(2,6-di-tert-butylphenol), 4,4′-tri-thiobis(2,6-di-tert-butylphenol), 2,2-thiodiethylenebis-[3-(3,5-di-tert-butyl-4-hydroxyphenyl) propionate], 2,4-bis(n-octylthio)-6-(4-hydroxy-3′,5′-di-tert-butylanilino)-1,3,5-triazine, N,N′-hexamethylenebis-(3,5-di-tert-butyl-4-hydroxyhydrocinnamide), N,N′-bis[3-(3,5-di-tert-butyl-4-hydroxyphenyl)propionyl]hydrazine, 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, tris(3,5-di-tert-butyl-4-hydroxyphenyl) isocyanurate, tris(3,5-di-tert-butyl-4-hydroxybenzyl) isocyanurate, 1,3,5-tris(4-tert-butyl-3-hydroxy-2,6-dimethylbenzyl) isocyanurate, 1,3,5-tris2-[3(3,5-di-tert-butyl-4-hydroxyphenyl)propionyloxy]ethyl isocyanurate, and tetrakis[methylene-3-(3′,5′-di-tert-butyl-4-hydroxyphenyl)propionate]methane. All of these stabilizers are easily available. The hindered phenol stabilizers can be used individually or in combination. The amount of each of the phosphorus stabilizer and hindered phenol stabilizer incorporated is, relative to 100 parts by weight of the resin component, preferably 0.0001 to 1 part by weight, more preferably 0.001 to 0.5 parts by weight, further preferably 0.005 to 0.3 parts by weight. When the amount of the stabilizer is much smaller than the above range, it is likely that excellent stabilization effect is difficult to obtain, and, when the amount of the stabilizer is much larger than the above range, it is likely that the resultant composition has poor physical properties.

(ii-iii) Heat Stabilizer Other than Those Mentioned Above

A heat stabilizer other than the above-mentioned phosphorus stabilizer and hindered phenol stabilizer can be incorporated into the resin composition of the invention. Preferred examples of such other heat stabilizers include a lactone stabilizer, such as a reaction product of 3-hydroxy-5,7-di-tert-butyl-furan-2-one and o-xylene. Details of such stabilizers are described in JPH07−233160A. Such a compound is commercially available as Irganox HP-136 (trademark, manufactured by CIBA SPECIALTY CHEMICALS Inc.), and the compound can be used. Further, a stabilizer having mixed the compound with a phosphite compound and a hindered phenol compound is commercially available. Preferred examples include Irganox HP-2921, manufactured by CIBA SPECIALTY CHEMICALS Inc. The amount of the lactone stabilizer incorporated is, relative to 100 parts by weight of the resin component, preferably 0.0005 to 0.05 parts by weight, more preferably 0.001 to 0.03 parts by weight. Further examples of other stabilizers include sulfur-containing stabilizers, such as pentaerythritol tetrakis(3-mercaptopropionate), pentaerythritol tetrakis(3-laurylthiopropionate), and glycerol-3-stearylthiopropionate. The amount of the sulfur-containing stabilizer incorporated is, relative to 100 parts by weight of the resin component, preferably 0.001 to 0.1 parts by weight, more preferably 0.01 to 0.08 parts by weight. An epoxy compound can be incorporated into the resin composition of the invention if necessary. The epoxy compound is incorporated for the purpose of suppressing corrosion of a mold, and basically any compound having an epoxy functional group can be used. Specific preferred examples of epoxy compounds include 3,4-epoxycyclohexylmethyl-3′,4′-epoxycyclohexyl carboxylate, a 1,2-epoxy-4-(2-oxiranyl)cyclohexane addition product of 2,2-bis(hydroxymethyl)-1-butanol, a copolymer of methyl methacylate and glycidyl methacylate, and a copolymer of styrene and glycidyl methacylate. The amount of the epoxy compound added is, relative to 100 parts by weight of the resin component, preferably 0.003 to 0.2 parts by weight, more preferably 0.004 to 0.15 parts by weight, further preferably 0.005 to 0.1 parts by weight.

(iii) Release Agent

In the resin composition of the invention, for the purpose of improving the productivity in molding the composition and reducing the strain of the molded article, a release agent can be further incorporated into the resin composition. As the release agent, one which has conventionally been known can be used. Examples of release agents include a saturated fatty acid ester, an unsaturated fatty acid ester, a polyolefin wax (a polyethylene wax, a 1-alkene polymer, or those which are modified with a functional group-containing compound, for example, modified with an acid, can be used), a silicone compound, a fluorine compound (e.g., a fluorine oil and the like, such as a polyfluoroalkyl ether), a paraffin wax, and beeswax. Especially preferred release agents include a fatty acid ester. The fatty acid ester is an ester of an aliphatic alcohol and an aliphatic carboxylic acid. The aliphatic alcohol may either a monohydric alcohol or a dihydric or polyhydric alcohol. The number of carbon atoms of the alcohol is in the range of 3 to 32, more preferably in the range of 5 to 30. Examples of the monohydric alcohols include dodecanol, tetradecanol, hexadecanol, octadecanol, eicosanol, tetracosanol, ceryl alcohol, and triacontanol. Examples of the polyhydric alcohols include pentaerythritol, dipentaerythritol, tripentaerythritol, polyglycerol (triglycerol to hexaglycerol), ditrimethlolpropane, xylitol, sorbitol, and mannitol. The fatty acid ester in the invention is more preferably a polyhydric alcohol. On the other hand, an aliphatic carboxylic acid having 3 to 32 carbon atoms is preferred, and an aliphatic carboxylic acid having 10 to 22 carbon atoms is especially preferred. Examples of the aliphatic carboxylic acids include saturated aliphatic carboxylic acids, such as decanoic acid, undecanoic acid, dodecanoic acid, tridecanoic acid, tetradecanoic acid, pentadecanoic acid, hexadecanoic acid (palmitic acid), heptadecanoic acid, octadecanoic acid (stearic acid), nonadecanoic acid, behenic acid, icosanoic acid, and docosanoic acid, and unsaturated aliphatic carboxylic acids, such as palmitoleic acid, oleic acid, linoleic acid, linolenic acid, eicosenoic acid, eicosapentaenoic acid, and cetoleic acid. Among these, preferred is an aliphatic carboxylic acid having 14 to 20 carbon atoms. Of these, preferred is a saturated aliphatic carboxylic acid. Especially preferred are stearic acid and palmitic acid. The above-mentioned aliphatic carboxylic acids including stearic acid and palmitic acid are generally produced from natural fats and oils, e.g., animal fats and oils, such as beef tallow and lard, or vegetable fats and oils, such as palm oil and sunflower oil, and therefore these aliphatic carboxylic acids are generally a mixture containing another carboxylic acid component having the different number of carbon atoms. Therefore, in the production of the fatty acid ester in the invention, an aliphatic carboxylic acid which is produced from natural fats and oils, and which is in the form of a mixture containing another carboxylic acid component, especially stearic acid or palmitic acid is preferably used. The fatty acid ester may be any of a partial ester and a full ester. However, when the fatty acid ester is a partial ester, the ester is generally likely to have such a high hydroxyl value that the resin easily suffers decomposition or the like at high temperatures, and therefore the fatty acid ester is more preferably a full ester. In view of the thermal stability, the fatty acid ester in the invention preferably has an acid value of 20 or less, more preferably in the range of 4 to 20, further preferably in the range of 4 to 12. The acid value can be substantially zero. The fatty acid ester more preferably has a hydroxyl value in the range of 0.1 to 30. Further, the fatty acid ester preferably has an iodine value of 10 or less. The iodine value can be substantially zero. These characteristic values can be determined by the method described in JIS K 0070.

The amount of the release agent contained is, relative to 100 parts by weight of the resin component, preferably 0.01 to 4.0 parts by weight, more preferably 0.05 to 3.0 parts by weight, further preferably 0.1 to 2.5 parts by weight.

### (iv) Dye and Pigment

The polycarbonate resin composition of the invention can further contain various types of dyes and pigments, providing a molded article exhibiting a variety of design properties. Examples of dyes and pigments used in the invention include a perylene dye, a coumarin dye, a thioindigo dye, an anthraquinone dye, a thioxanthone dye, ferrocyanide of Prussian blue or the like, a perinone dye, a quinoline dye, a quinacridone dye, a dioxazine dye, an isoindolinone dye, and a phthalocyanine dye. Further, the polycarbonate resin composition of the invention can obtain more excellent metallic color by having incorporated a metallic pigment. As a metallic pigment, an aluminum powder is preferred. Further, by incorporating a fluorescent brightener or another fluorescent dye emitting a light into the polycarbonate resin composition, a further excellent design effect utilizing the color emitted can be imparted to the polycarbonate resin composition. The amount of the dye or pigment contained is, relative to 100 parts by weight of the resin component, preferably 0.00001 to 1 part by weight, more preferably 0.00005 to 0.5 parts by weight.

### (v) Fluorescent Brightener

With respect to the fluorescent brightener in the resin composition of the invention, there is no particular limitation as long as it is used for improving the color tone of a resin or the like to white or bluish white, and examples include stilbene, benzimidazole, benzoxazole, naphthalimide, rhodamine, coumarin, and oxazine compounds. Specific examples include CI Fluorescent Brightener 219:1, EASTOBRITE OB-1, manufactured by Eastman Chemical Company, and “Hakkol PSR”, manufactured by Showa Chemical Industry Co., Ltd. The fluorescent brightener has an effect such that it absorbs energy in the ultraviolet region of a ray of light and emits the energy to the visible range. The amount of the fluorescent brightener contained is, relative to 100 parts by weight of the resin component, preferably 0.001 to 0.1 parts by weight, more preferably 0.001 to 0.05 parts by weight. Even when the amount of the fluorescent brightener is more than 0.1 parts by weight, the improvement effect for the color tone of the composition is slight.

### (vi) Compound Having Heat Ray Absorbing Ability

The polycarbonate resin composition of the invention can contain a compound having heat ray absorbing ability. Preferred examples of such compounds include various types of metal compounds having excellent near infrared ray absorbing ability, e.g., a phthalocyanine near infrared ray absorber, a metal oxide near infrared ray absorber, such as ATO, ITO, iridium oxide, ruthenium oxide, imonium oxide, and titanium oxide, and a metal boride or a tungsten oxide near infrared ray absorber, such as lanthanum boride, cerium boride, and tungsten boride, and a carbon filler. With respect to the phthalocyanine near infrared ray absorber, for example, MIR-362, manufactured by Mitsui Chemicals, Inc., is commercially and easily available. Examples of carbon fillers include carbon black, graphite (including natural graphite and artificial graphite), and fullerene, and preferred are carbon black and graphite. These can be used individually or in combination. The amount of the phthalocyanine near infrared ray absorber contained is, relative to 100 parts by weight of the resin component, preferably 0.0005 to 0.2 parts by weight, more preferably 0.0008 to 0.1 parts by weight, further preferably 0.001 to 0.07 parts by weight. The amount of the metal oxide near infrared ray absorber, metal boride near infrared ray absorber, or carbon filler contained in the polycarbonate resin composition of the invention is preferably in the range of 0.1 to 200 ppm (by weight), more preferably in the range of 0.5 to 100 ppm.

(vii) Light Diffusing Agent

In the polycarbonate resin composition of the invention, a light diffusing agent can be incorporated into the resin composition to impart a light diffusion effect. Examples of the light diffusing agents include polymer fine particles, inorganic fine particles having a low refractive index, such as calcium carbonate, and a composite thereof. The above-mentioned polymer fine particles are fine particles which have already been known as a light diffusing agent for polycarbonate resin. More preferred examples include acrylic crosslinked particles having a particle diameter of several μm and silicone crosslinked particles, such as polyorganosilsesquioxane. Examples of shapes of the light diffusing agent include a spherical shape, a disc shape, a prism shape, and an indefinite shape. The spherical shape need not be a complete sphere and includes a sphere which is deformed, and the prism shape includes a cube. A preferred light diffusing agent has a spherical shape, and the more uniform the particle diameter of the agent, the more preferred the agent is. The amount of the light diffusing agent contained is, relative to 100 parts by weight of the resin component, preferably 0.005 to 20 parts by weight, more preferably 0.01 to 10 parts by weight, further preferably 0.01 to 3 parts by weight. Two or more light diffusing agents can be used in combination.

(viii) White Pigment for High Light Reflection

In the polycarbonate resin composition of the invention, a white pigment for high light reflection can be incorporated into the resin composition to impart a high light reflection effect. With respect to the white pigment, especially preferred is a titanium dioxide (particularly, titanium dioxide treated with an organic surface treatment agent, such as silicone) pigment. The amount of the contained white pigment for high light reflection is, relative to 100 parts by weight of the resin component, preferably 3 to 30 parts by weight, more preferably 8 to 25 parts by weight. Two or more white pigments for high light reflection can be used in combination.

### (ix) Antistatic Agent

The polycarbonate resin composition of the invention may be required to have antistatic performance, and, in such a case, the polycarbonate resin composition preferably contains an antistatic agent. Examples of antistatic agents include (1) phosphonium organosulfonates, e.g., phosphonium arylsulfonates, such as phosphonium dodecylbenzenesulfonate, and phosphonium alkylsulfonates, and phosphonium borates, such as phosphonium tetrafluoroborate. The amount of the phosphonium salt contained is, relative to 100 parts by weight of the resin component, advantageously 5 parts by weight or less, preferably 0.05 to 5 parts by weight, more preferably 1 to 3.5 parts by weight, further preferably in the range of 1.5 to 3 parts by weight. Examples of antistatic agents include (2) alkali (earth) metal salts of organosulfonic acid, such as lithium organosulfonate, sodium organosulfonate, potassium organosulfonate, cesium organosulfonate, rubidium organosulfonate, calcium organosulfonate, magnesium organosulfonate, and barium organosulfonate. Such a metal salt of organosulfonic acid is used also as a flame retardant. More specific examples of the metal salts include metal salts of dodecylbenzenesulfonic acid, and metal salts of perfluoroalkanesulfonic acid. The amount of the organosulfonic acid alkali (earth) metal salt contained is, relative to 100 parts by weight of the resin component, advantageously 0.5 parts by weight or less, preferably 0.001 to 0.3 parts by weight, more preferably 0.005 to 0.2 parts by weight. Particularly, preferred is an alkali metal salt, such as potassium, cesium, or rubidium.

Examples of antistatic agents include (3) ammonium organosulfonates, such as ammonium alkylsulfonates and ammonium arylsulfonates. The amount of the ammonium organosulfonate is advantageously 0.05 parts by weight or less, relative to 100 parts by weight of the resin component. Examples of antistatic agents include (4) a polymer containing a poly(oxyalkylene) glycol component as a constitutional component, such as polyether ester amide. The amount of the polymer is advantageously 5 parts by weight or less, relative to 100 parts by weight of the resin component.

### (x) Other Additives

In the polycarbonate resin composition of the invention, a fluidity-improving agent, an anti-fungus agent, a dispersant, such as liquid paraffin, a photocatalytic stainproofing agent, a photochromic agent, or the like can be incorporated into the composition.

### (Production of the Resin Composition)

In producing the resin composition of the invention, an arbitrary method is employed. For example, there can be mentioned a method in which the components A to D and other optional additives are satisfactorily mixed using a premixing means, such as a twin-cylinder mixer, a Henschel mixer, a mechanochemical machine, or an extrusion mixer, and then, if necessary, the resultant premix is subjected to granulation by means of an extrusion granulator, a briquetting machine, or the like, and then melt-kneaded by a melt kneading machine, such as a vented twin-screw extruder, and then pelletized by a pelletizer.

Further examples include a method in which the components are individually and independently fed to a melt kneading machine, such as a vented twin-screw extruder, and a method in which some of the components are premixed, and then fed to a melt kneading machine independently from the remaining components. As an example of the method for premixing some of the components, there can be mentioned a method in which the components other than the components A and B are preliminarily premixed, and then mixed with the component A and the resin of the component B or directly fed to an extruder.

With respect to the premixing method, in the case where the component B is in the form of a powder, as an example of the method, there can be mentioned a method in which a part of the powder and an additive to be incorporated are blended to produce a masterbatch of the additive diluted with the powder, and the masterbatch is used in premixing. Further examples include a method in which one component is independently fed to a melt-extruder during the extrusion. When the components to be incorporated include one which is in a liquid state, a so-called injection apparatus or adding apparatus can be used for feeding such a liquid component into the melt-extruder.

With respect to the extruder, an extruder having a vent capable of degassing moisture in the raw materials or volatilized gas generated from the melt-kneaded resin can be preferably used. The vent is preferably provided with a vacuum pump for efficiently discharging the generated moisture or volatilized gas out of the extruder. Further, a screen for removing foreign matter mixed into the raw materials to be extruded and the like is provided in the zone before the extruder dice portion, making it possible to remove foreign matter from the resin composition. Examples of the screens include a woven metal wire, a screen changer, and a sintered metal plate (such as a disc filter).

Examples of melt kneading machines include a twin-screw extruder, a Banbury mixer, a mixing roll, a single-screw extruder, and a triple-screw or multi-screw extruder.

With respect to the resin extruded as mentioned above, the resin is directly pelletized by cutting, or strands are formed from the resin and then the strands are pelletized by cutting using a pelletizer. When there is a need to reduce the effect of dust or the like from the outside on the resin being pelletized, it is preferred that the atmosphere surrounding the extruder is cleaned. Further, in the production of the pellets, using various methods that have already been proposed in connection with a polycarbonate resin for optical disc, narrowing the shape distribution of the pellets, reduction of the materials mistakenly cut, reduction of a finely divided powder generated during the transportation, and reduction of bubbles (vacuum bubbles) generated inside the strands or pellets can be appropriately achieved. By virtue of these measures, the molding cycle can be highly improved, and the rate of generation of a failure, such as silver streaking, can be reduced. With respect to the shape of the pellets, the pellets can be in a general shape, such as a cylinder, a prism, or a sphere, but is more preferably in the shape of a cylinder. The diameter of the cylinder is preferably 1 to 5 mm, more preferably 1.5 to 4 mm, further preferably 2 to 3.3 mm. On the other hand, the length of the cylinder is preferably 1 to 30 mm, more preferably 2 to 5 mm, further preferably 2.5 to 3.5 mm.

### (Molded Article Comprising the Resin Composition of the Present Invention)

With respect to the resin composition of the invention, generally, the pellets obtained from the resin composition by the above-described method are subjected to injection molding, producing various types of products. In the injection molding, a molded article can be obtained not only by a general molding method but also using an injection molding method appropriately selected according to the object, such as injection compression molding, injection press molding, gas-assisted injection molding, foam molding (including foam molding by pouring of a supercritical fluid), insert molding, in-mold coating molding, insulated mold molding, rapid heating-and-cooling mold molding, two-color molding, sandwich molding, or ultra-high speed injection molding. Advantages of these various molding methods have been widely known. Any of molding of a cold-runner system and molding of a hot-runner system can be selected.

### (Impact Resistance)

The polycarbonate resin composition of the invention preferably has values of notched Charpy impact strength measured in accordance with ISO 179 of 40 kJ/m 2 or more, more preferably 50 kJ/m 2 or more, further preferably 60 kJ/m 2 or more. When the measured value of notched Charpy impact strength is less than the above appropriate range, it is difficult to apply the resin composition to various uses.

### (Extremely Low-Temperature Impact Strength)

The polycarbonate resin composition of the invention preferably has values of notched Charpy impact strength measured with respect to the test specimen cooled to −30° C. in accordance with ISO 179 of 25 kJ/m 2 or more, more preferably 30 kJ/m 2 or more, further preferably 35 kJ/m 2 or more. When the measured value of notched Charpy impact strength is less than the above appropriate range, it is difficult to apply the resin composition to outdoor structural members and various housing members for extremely cold regions and automobile related parts.

### (Durability)

The polycarbonate resin composition of the invention preferably has a retention of 50% or more, as determined from values of notched Charpy impact strength measured with respect to the test specimen before and after subjected to the water exposure test in accordance with UL 746C, and represented by the following formula, more preferably has a retention of 60% or more, further preferably 70% or more. When the retention is less than the above appropriate range, it is difficult to apply the resin composition to structural members and various housing members for outdoor use and automobile related parts.

Retention (%)=(Charpy impact strength after the water exposure test/Charpy impact strength before the water exposure test)×100

Further, similarly with respect to the test specimen before and after subjected to the water exposure test in accordance with UL 746C, it is desired that the UL 94 flame retardancy rating of the test specimen is maintained. When the flame retardancy rating is not maintained, it is difficult to apply the resin composition to structural members and various housing members for outdoor use and automobile related parts.

The embodiments of the present invention are intensive examples of preferred ranges of each of the above-described requirements and, for example, representative examples of the embodiments are described in Examples below. Of course these embodiments and Examples should not be construed as limiting the scope of the present invention.

### EXAMPLES

Hereinbelow, the present invention will be described in more detail with reference to the following Examples. In the following Examples, “part(s)” indicates “part(s) by weight” and “%” indicates “% by weight” unless otherwise specified. The evaluation was conducted in accordance with the methods described below.

### (1) Evaluation of Polycarbonate-Polydiorganosiloxane Copolymer

### (i) Viscosity Average Molecular Weight

A specific viscosity (li s p) at 20° C., which is calculated from the following formula, was determined using an Ostwald viscometer with respect to a solution obtained by dissolving 0.7 g of the polycarbonate-polydiorganosiloxane copolymer in 100 ml of methylene chloride,

Specific viscosity(ηₛₚ)=(t−t₀)/t₀

[wherein t₀ is the duration (seconds) of falling of methylene chloride, and t is the duration (seconds) of falling of a sample solution]
and, from the determined specific viscosity (ηₛₚ), a viscosity average molecular weight My was determined by calculation using the following mathematical formula.
ηₛₚ/c=[η]+0.45^{×[η]2}c (wherein [η] is an intrinsic viscosity)
[η]=1.23×10⁻⁴MV^{0.83}
c=0.7

### (ii) Total Light Transmittance

The polycarbonate-polydiorganosiloxane copolymer was kneaded at a temperature of 280° C. by means of a vented twin-screw extruder (KTX-30 (diameter: 30 mmφ), manufactured by Kobe Steel Ltd.), followed by pelletization. The resultant pellets were hot-air dried at 120° C. for 5 hours, and then subjected to molding using an injection molding machine (JSW J-75E111, manufactured by The Japan Steel Works, Ltd.) at a molding temperature of 280° C., at a mold temperature of 80° C., and with a molding cycle of 50 seconds, obtaining a three-step plate having a width of 50 mm, a length of 90 mm, a thickness of 3.0 mm (length: 20 mm), 2.0 mm (length: 45 mm), and 1.0 mm (length: 25 mm) from the gate side, and an arithmetic average roughness (Ra) of 0.03 μm. A total light transmittance of the three-step plate at the 2.0 mm-thick portion thereof was measured using Haze Meter NDH 2000, manufactured by Nippon Denshoku Industries Co., Ltd., in accordance with ASTM D1003.

(iii) Average Size and Standardized Dispersion of Polydiorganosiloxane Domains

Using the three-step plate formed in (ii) above, with respect to the intersection of 5 mm from the end and 5 mm from the side of the 1.0 mm-thick portion of the plate, an average size and particle size distribution (standardized dispersion) of the polydiorganosiloxane domains were measured using an X-ray diffraction apparatus (RINT-TTRII, manufactured by Rigaku Corporation). As an X-ray source, a CuKα characteristic X-ray (wavelength: 0.1541841 nm) was used at a tube voltage of 50 kV and at a tube current of 300 mA. The small angle scattering optical system was as follows: Slit: 1st 0.03 mm, HS 10 mm, SS 0.2 mm, RS 0.1 mm. The measurement was conducted by a nonsymmetrical scanning method (28 scanning) under the conditions: FT 0.01° step, 4 sec/step, and scanning range: 0.06−3°. In the analysis for curve fitting, small angle scattering analysis software NANO-Solver (Ver. 3.3), manufactured by Rigaku Corporation, was used. The analysis was made, on the assumption that the copolymer has an aggregate structure in which polydiorganosiloxane spherical domains are dispersed in a polycarbonate polymer matrix and there is a dispersion in the particle size distribution, under conditions such that the density of the polycarbonate matrix was 1.2 g/cm³ and the density of the polydiorganosiloxane domains was 1.1 g/cm³, in an isolated particle model which does not consider the interparticle interaction (interparticle interference).

### (2) Evaluation of the Resin Composition

### (i) Durability

Using an ISO flexural test specimen having a thickness of 3 mm, which was obtained by the below-mentioned method, measurement of a notched Charpy impact strength was conducted in an atmosphere at 23° C. in accordance with ISO 179. Then, in accordance with the UL 746C water exposure test provided by Underwriters Laboratories Inc., U.S.A., the flexural test specimen was immersed in warm water at 70° C. for 7 days, and then measurement of a notched Charpy impact strength was conducted in an atmosphere at 23° C. in accordance with ISO 179. From the obtained results, a retention of the notched Charpy impact strength was determined by calculation using the following formula.

Retention (%)=(Charpy impact strength after the water exposure test/Charpy impact strength before the water exposure test)×100

### (ii) −30° C. Charpy Impact Strength

Using an ISO flexural test specimen having a thickness of 3 mm, which was obtained by the below-mentioned method, measurement of a notched Charpy impact strength was conducted in an atmosphere at −30° C. in accordance with ISO 179.

(iii) Flame Retardancy

In accordance with the UL94 vertical burning test provided by Underwriters Laboratories Inc., U.S.A., using a molded article having a thickness of 1.5 mm, which was obtained by the below-mentioned method, a burning test was conducted. Then, in accordance with the UL 746C water exposure test provided by Underwriters Laboratories Inc., U.S.A., the flexural test specimen was immersed in warm water at 70° C. for 7 days, and then a similar evaluation was conducted. The results were evaluated using ratings V-0, V-1, V-2, and not V.

### Examples 1 to 12 and Comparative Examples 1 to 11

The components A to D and additives were weighed according to the formulation shown in Tables 1 and 2, and uniformly mixed using a blender, and melt-kneaded using a vented twin-screw extruder to obtain pellets. With respect to each of the additives to be used, a premix of the additive and the polycarbonate resin at a 10- to 100-fold concentration of the amount of the additive to be incorporated as a yardstick was preliminarily prepared, and then mixed into the whole of the composition using a blender. As a vented twin-screw extruder, KTX-30 (diameter: 30 mmφ), manufactured by Kobe Steel Ltd., was used. The mixture was extruded into strands under conditions such that the cylinder temperature and the dice temperature were 280° C., the screw revolution speed was 150 rpm, the discharge rate was 20 kg/h, and the degree of vacuum for vent was 3 kPa, and the strands were cooled in a water bath and then cut and pelletized using a pelletizer. The resultant pellets were dried by a circulating hot air dryer at 100° C. for 6 hours, and then subjected to molding using an injection molding machine (JSW J-75EIII, manufactured by The Japan Steel Works, Ltd.) at a cylinder temperature of 280° C. and at a mold temperature of 80° C., obtaining an ISO flexural test specimen (ISO 179) and a UL test specimen. The results of the evaluations are shown in Tables 1 and 2.

TABLE 1

| | | | | Example | | | | | | | | | | | |
|---|---|---|---|---|---|---|---|---|---|---|---|---|---|---|---|
| | | Mv | Unit | 1 | 2 | 3 | 4 | 5 | 6 | 7 | 8 | 9 | 10 | 11 | 12 |
| Component A | A-1 | 23,900 | Parts by | 50 | 50 | 50 | 50 | 25 | 75 | 50 | 50 | 50 | 50 | 50 | 50 |
| | | | weight | | | | | | | | | | | | |
| | A-2 | 19,700 | Parts by | | | | | | | | | | | | |
| | | | weight | | | | | | | | | | | | |
| | A-3 | 35,000 | Parts by | | | | | | | | | | | | |
| | | | weight | | | | | | | | | | | | |
| Component B | B-1 | 30,000 | Parts by | | | | | | | | | | | | |
| | | | weight | | | | | | | | | | | | |
| | B-2 | 23,900 | Parts by | 50 | 50 | 50 | 50 | 75 | 25 | | | | 50 | 50 | |
| | | | weight | | | | | | | | | | | | |
| | B-3 | 22,400 | Parts by | | | | | | | 50 | | | | | |
| | | | weight | | | | | | | | | | | | |
| | B-4 | 19,700 | Parts by | | | | | | | | 50 | | | | 50 |
| | | | weight | | | | | | | | | | | | |
| | B-5 | 16,000 | Parts by | | | | | | | | | 50 | | | |
| | | | weight | | | | | | | | | | | | |
| | B-6 | 14,000 | Parts by | | | | | | | | | | | | |
| | | | weight | | | | | | | | | | | | |
| Mv (component A)/Mv (component B) | | | — | 1.00 | 1.00 | 1.00 | 1.00 | 1.00 | 1.00 | 1.07 | 1.21 | 1.40 | 1.00 | 1.00 | 1.21 |
| Component C | C-1 | | Parts by | 3 | 3 | 3 | | | | | | | | | |
| | | | weight | | | | | | | | | | | | |
| | C-2 | | Parts by | | | | 3 | 3 | 3 | 3 | 3 | 3 | 5 | 1 | 1 |
| | | | weight | | | | | | | | | | | | |
| | C-3 | | Parts by | | | | | | | | | | | | |
| | | | weight | | | | | | | | | | | | |
| Component D | D-1 | | Parts by | 0.2 | 0.2 | | | | | | | | | | |
| | | | weight | | | | | | | | | | | | |
| | D-2 | | Parts by | | | 0.4 | 0.4 | 0.4 | 0.4 | 0.4 | 0.4 | 0.4 | 0.4 | 0.4 | 0.4 |
| | | | weight | | | | | | | | | | | | |
| Other | Release | | Parts by | | 0.2 | 0.2 | 0.2 | 0.2 | 0.2 | 0.2 | 0.2 | 0.2 | 0.2 | 0.2 | 0.2 |
| components | agent | | weight | | | | | | | | | | | | |
| | Ultraviolet | | Parts by | | 0.2 | 0.2 | 0.2 | 0.2 | 0.2 | 0.2 | 0.2 | 0.2 | 0.2 | 0.2 | 0.2 |
| | light absorber | | weight | | | | | | | | | | | | |
| | Heat | | Parts by | | 0.1 | 0.1 | 0.1 | 0.1 | 0.1 | 0.1 | 0.1 | 0.1 | 0.1 | 0.1 | 0.1 |
| | stabilizer-1 | | weight | | | | | | | | | | | | |
| | Heat | | Parts by | | 0.1 | 0.1 | 0.1 | 0.1 | 0.1 | 0.1 | 0.1 | 0.1 | 0.1 | 0.1 | 0.1 |
| | stabilizer-2 | | weight | | | | | | | | | | | | |
| Physical | Charpy | Before water | kJ/m² | 80 | 75 | 79 | 79 | 82 | 68 | 79 | 70 | 60 | 60 | 80 | 77 |
| properties | impact | exposure test | | | | | | | | | | | | | |
| | strength | After water | kJ/m² | 65 | 50 | 56 | 56 | 64 | 41 | 55 | 40 | 31 | 40 | 67 | 60 |
| | (23° C.) | exposure test | | | | | | | | | | | | | |

| | | | | | | | | | | | | | |
|---|---|---|---|---|---|---|---|---|---|---|---|---|---|
| Retention | % | 81 | 67 | 71 | 71 | 78 | 60 | 70 | 57 | 52 | 67 | 84 | 78 |
| Charpy impact | kJ/m² | 60 | 50 | 58 | 58 | 35 | 56 | 54 | 45 | 30 | 30 | 62 | 57 |
| strength | | | | | | | | | | | | | |
| (−30° C.) | | | | | | | | | | | | | |
| Flame retardancy | — | V-0 | V-0 | V-0 | V-0 | V-0 | V-0 | V-0 | V-0 | V-0 | V-0 | V-0 | V-0 |
| 1.5 mm | | | | | | | | | | | | | |
| Flame retardancy after | — | V-0 | V-0 | V-0 | V-0 | V-0 | V-0 | V-0 | V-0 | V-0 | V-0 | V-0 | V-0 |
| water exposure 1.5 mm | | | | | | | | | | | | | |

TABLE 2

| | | | | Comparative Example | | | | | | | | | | |
|---|---|---|---|---|---|---|---|---|---|---|---|---|---|---|
| | | Mv | Unit | 1 | 2 | 3 | 4 | 5 | 6 | 7 | 8 | 9 | 10 | 11 |
| Component A | A-1 | 23,900 | Parts by | | 50 | 50 | | 100 | | 50 | 50 | 50 | 50 | 50 |
| | | | weight | | | | | | | | | | | |
| | A-2 | 19,700 | Parts by | 50 | | | | | | | | | | |
| | | | weight | | | | | | | | | | | |
| | A-3 | 35,000 | Parts by | | | | 50 | | | | | | | |
| | | | weight | | | | | | | | | | | |
| Component B | B-1 | 30,000 | Parts by | | 50 | | | | | | | | | |
| | | | weight | | | | | | | | | | | |
| | B-2 | 23,900 | Parts by | | | | 50 | | 100 | 50 | 50 | 50 | 50 | 50 |
| | | | weight | | | | | | | | | | | |
| | B-3 | 22,400 | Parts by | | | | | | | | | | | |
| | | | weight | | | | | | | | | | | |
| | B-4 | 19,700 | Parts by | 50 | | | | | | | | | | |
| | | | weight | | | | | | | | | | | |
| | B-5 | 16,000 | Parts by | | | | | | | | | | | |
| | | | weight | | | | | | | | | | | |
| | B-6 | 14,000 | Parts by | | | 50 | | | | | | | | |
| | | | weight | | | | | | | | | | | |
| Mv (component A)/Mv (component B) | | | — | 1.00 | 0.80 | 1.71 | 1.46 | — | — | 1.00 | 1.00 | 1.00 | 1.00 | 1.00 |
| Component C | C-1 | | Parts by | | | | | | | | | | | |
| | | | weight | | | | | | | | | | | |
| | C-2 | | Parts by | 3 | 3 | 3 | 3 | 3 | 3 | 0.1 | 8 | | 3 | 3 |
| | | | weight | | | | | | | | | | | |
| | C-3 | | Parts by | | | | | | | | | 3 | | |
| | | | weight | | | | | | | | | | | |
| Component D | D-1 | | Parts by | | | | | | | | | | | |
| | | | weight | | | | | | | | | | | |
| | D-2 | | Parts by | 0.4 | 0.4 | 0.4 | 0.4 | 0.4 | 0.4 | 0.4 | 0.4 | 0.4 | 0.1 | 2 |
| | | | weight | | | | | | | | | | | |
| Other | Release | | Parts by | 0.2 | 0.2 | 0.2 | 0.2 | 0.2 | 0.2 | 0.2 | 0.2 | 0.2 | 0.2 | 0.2 |
| components | agent | | weight | | | | | | | | | | | |
| | Ultraviolet | | Parts by | 0.2 | 0.2 | 0.2 | 0.2 | 0.2 | 0.2 | 0.2 | 0.2 | 0.2 | 0.2 | 0.2 |
| | light absorber | | weight | | | | | | | | | | | |
| | Heat | | Parts by | 0.1 | 0.1 | 0.1 | 0.1 | 0.1 | 0.1 | 0.1 | 0.1 | 0.1 | 0.1 | 0.1 |
| | stabilizer-1 | | weight | | | | | | | | | | | |
| | Heat | | Parts by | 0.1 | 0.1 | 0.1 | 0.1 | 0.1 | 0.1 | 0.1 | 0.1 | 0.1 | 0.1 | 0.1 |
| | stabilizer-2 | | weight | | | | | | | | | | | |
| Physical | Charpy | Before water | kJ/m² | 60 | 80 | 52 | Molding | 60 | 10 | 80 | 50 | 78 | 80 | 55 |
| properties | impact | exposure test | | | | | impossible | | | | | | | |
| | strength | After water | kJ/m² | 20 | 66 | 18 | | 20 | 6 | 70 | 10 | 20 | 57 | 20 |
| | (23° C.) | exposure test | | | | | | | | | | | | |

| | | | | | | | | | | | |
|---|---|---|---|---|---|---|---|---|---|---|---|
| Retention | % | 33 | 83 | 35 | 33 | 60 | 88 | 20 | 26 | 71 | 36 |
| Charpy impact | kJ/m² | 23 | 60 | 15 | 40 | 8 | 63 | 20 | 48 | 60 | 19 |
| strength | | | | | | | | | | | |
| (−30° C.) | | | | | | | | | | | |
| Flame retardancy | — | V-0 | V-1 | V-0 | V-0 | V-0 | not V | V-0 | V-0 | not V | V-0 |
| 1.5 mm | | | | | | | | | | | |
| Flame retardancy after | — | V-0 | V-1 | V-0 | V-0 | V-0 | not V | V-0 | not V | not V | V-0 |
| water exposure 1.5 mm | | | | | | | | | | | |

The raw materials shown below were used.

### (Component A)

A-1: Polycarbonate-polydiorganosiloxane copolymer (viscosity average molecular weight: 23,900; PDMS content: 8.4%; PDMS polymerization degree: 37; average domain size of polydiorganosiloxane domains: 10.8 nm; standardized dispersion: 18.9; total light transmittance: 89.6%)
A-2: Polycarbonate-polydiorganosiloxane copolymer (viscosity average molecular weight: 19,700; PDMS content: 8.4%; PDMS polymerization degree: 37; average domain size of polydiorganosiloxane domains: 10.1 nm; standardized dispersion: 18.5; total light transmittance: 89.7%)
A-3: Polycarbonate-polydiorganosiloxane copolymer (viscosity average molecular weight: 35,000; PDMS content: 8.4%; PDMS polymerization degree: 37; average domain size of polydiorganosiloxane domains: 12.1 nm; standardized dispersion: 18.0; total light transmittance: 89.3%) which was prepared using 2,2-bis(4-hydroxyphenyl)propane (bisphenol A) as the dihydric phenol (I) that derives the carbonate constitutional unit represented by the formula [1], and using, as the dihydroxyaryl-terminal polydiorganosiloxane (II) that derives the carbonate constitutional unit represented by the formula [3], a polydiorganosiloxane compound represented by the formula [8] below (X-22−1821, manufactured by Shin-Etsu Chemical Co., Ltd.)

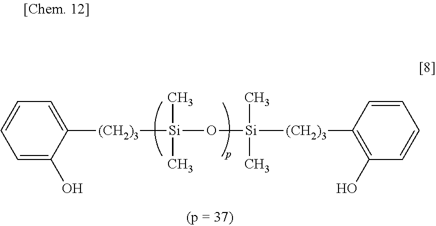

### (Component B)

B-1: Polycarbonate resin (polycarbonate resin powder having a viscosity average molecular weight of 30,000, which was prepared from bisphenol A and phosgene by a general method)
B-2: Polycarbonate resin (polycarbonate resin powder having a viscosity average molecular weight of 23,900, which was prepared from bisphenol A and phosgene by a general method)
B-3: Polycarbonate resin (polycarbonate resin powder having a viscosity average molecular weight of 22,400, which was prepared from bisphenol A and phosgene by a general method)
B-4: Polycarbonate resin (polycarbonate resin powder having a viscosity average molecular weight of 19,700, which was prepared from bisphenol A and phosgene by a general method)
B-5: Polycarbonate resin (polycarbonate resin powder having a viscosity average molecular weight of 16,000, which was prepared from bisphenol A and phosgene by a general method)
B-6: Polycarbonate resin (polycarbonate resin powder having a viscosity average molecular weight of 14,000, which was prepared from bisphenol A and phosgene by a general method)

### (Component C)

C-1: Cyclic phenoxyphosphazene of the formula (7) below, in which the content of the trimer (n=3 for the formula (7)) is 68 mol %, the content of the tetramer (n=4) is 18 mol %, and the content of the polymer (n=5 or more) is 14 mol %
C-2: Cyclic phenoxyphosphazene of the formula (7) below, in which the content of the trimer (n=3 for the formula (7)) is 100 mol %

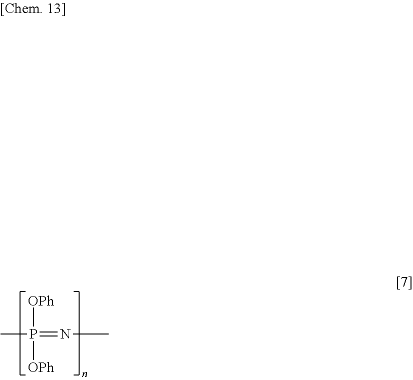

Wherein Ph represents a phenyl group.
C-3: Phosphate composed mainly of bisphenol A bis(diphenyl phosphate) (CR-741 (trade name), manufactured by Daihachi Chemical Industry Co., Ltd.)

### (Component D)

D-1: PTFE (Polyflon MPA FA500H (trade name), manufactured by Daikin Industries, Ltd.)
D-2: Coated PTFE (polytetrafluoroethylene coated with a styrene-acrylonitrile copolymer (polytetrafluoroethylene content: 50% by weight), SN3307PF (trade name), manufactured by Guangzhou Shine Polymer Technology Co., Ltd.)

### (Other Components)

Release agent: Pentaerythritol fatty acid ester release agent (Rikester EW-400 (trade name), manufactured by Riken Vitamin Co., Ltd.)
Ultraviolet light absorber: (TINUVIN 234 (trade name), manufactured by BASF AG)
Heat stabilizer-1: Phenolic heat stabilizer (IRGANOX 1076 (trade name), manufactured by BASF AG)
Heat stabilizer-2: Phosphorus heat stabilizer (IRGAFOS 168 (trade name), manufactured by BASF AG)

1. A polycarbonate resin composition comprising, relative to 100 parts by weight of a resin component containing 10 to 90 parts by weight of (A) a polycarbonate-polydiorganosiloxane copolymer (component A) and 90 to 10 parts by weight of (B) a polycarbonate resin (component B), 0.5 to 7 parts by weight of (C) a phosphazene compound (component C) and 0.1 to 0.5 parts by weight of (D) a fluorine-containing anti-dripping agent (component D), wherein the ratio of the viscosity average molecular weight of the component A to that of the component B (Mv (component A)/Mv (component B)) is 1 to 1.5, and the component A satisfies the following (i) and (ii):
(i) the component A is a polycarbonate-polydiorganosiloxane copolymer comprising a polycarbonate block represented by the following general formula [1] and a polydiorganosiloxane block represented by the following general formula [3]; and
(ii) the component A has a viscosity average molecular weight of 23,000 to 30,000, 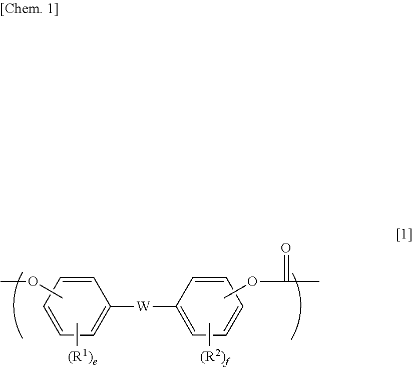
wherein, in the general formula [1], each of R¹ and R² independently represents a group selected from the group consisting of a hydrogen atom, a halogen atom, an alkyl group having 1 to 18 carbon atoms, an alkoxy group having 1 to 18 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 14 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, each of e and f is an integer of 1 to 4, and W is a single bond or at least one group selected from the group consisting of groups represented by the following general formula [2]: 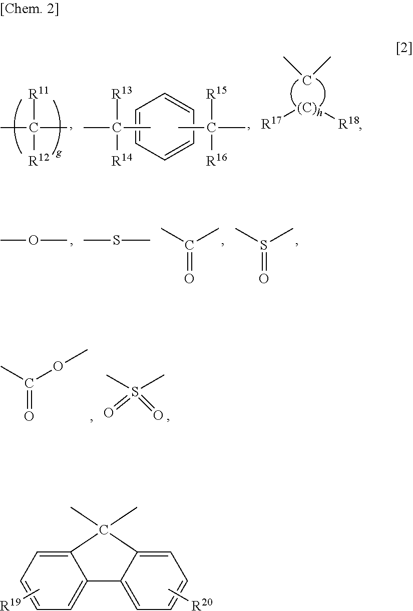
wherein, in the general formula [2], each of R¹¹, R¹², R¹³, R¹⁴, R¹⁵, R¹⁶, R¹⁷, and R¹⁸ independently represents a group selected from the group consisting of a hydrogen atom, an alkyl group having 1 to 18 carbon atoms, an aryl group having 6 to 14 carbon atoms, and an aralkyl group having 7 to 20 carbon atoms, each of R¹⁹ and R²⁰ independently represents a group selected from the group consisting of a hydrogen atom, a halogen atom, an alkyl group having 1 to 18 carbon atoms, an alkoxy group having 1 to 10 carbon atoms, a cycloalkyl group having 6 to 20 carbon atoms, a cycloalkoxy group having 6 to 20 carbon atoms, an alkenyl group having 2 to 10 carbon atoms, an aryl group having 6 to 14 carbon atoms, an aryloxy group having 6 to 10 carbon atoms, an aralkyl group having 7 to 20 carbon atoms, an aralkyloxy group having 7 to 20 carbon atoms, a nitro group, an aldehyde group, a cyano group, and a carboxyl group, wherein when there are a plurality of groups for each substituent, the groups are the same or different, g is an integer of 1 to 10, and h is an integer of 4 to 7, 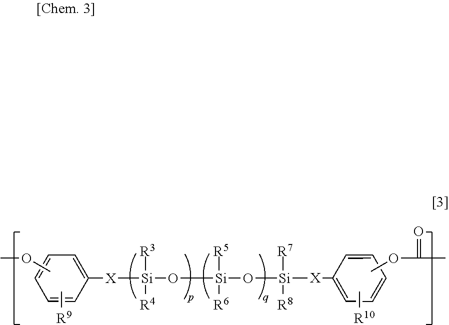
wherein, in the general formula [3], each of R³, R⁴, R⁵, R⁶, R⁷, and R⁸ is independently a hydrogen atom, an alkyl group having 1 to 12 carbon atoms, or a substituted or unsubstituted aryl group having 6 to 12 carbon atoms, each of R⁹ and R¹⁰ is independently a hydrogen atom, a halogen atom, an alkyl group having 1 to 10 carbon atoms, or an alkoxy group having 1 to 10 carbon atoms, p is a natural number, q is 0 or a natural number, wherein the average chain length p+q is a natural number of 30 to 60, and X is a divalent aliphatic group having 2 to 8 carbon atoms.

2. The polycarbonate resin composition according to claim 1, wherein the component A is a polycarbonate-polydiorganosiloxane copolymer which has an aggregate structure in which polydiorganosiloxane domains are dispersed in a polycarbonate matrix, wherein the polydiorganosiloxane domains have an average size of 5 to 15 nm and a standardized dispersion of 25% or less, and which has a total light transmittance of 88% or more.

3. The polycarbonate resin composition according to claim 1, wherein the component C is a phosphazene containing a phosphazene cyclic trimer in an amount of 98.5 mol % or more.

4. A molded article comprising the polycarbonate resin composition according to claim 1.
